(19) United States
(12) Patent Application Publication
(10) Pub. No.: US 2008/0147689 A1
(43) Pub. Date: Jun. 19, 2008

(54) TEST DATA REGISTRATION METHOD, PROGRAM AND APPARATUS

(75) Inventors: Tadahiro UEHARA, Kawasaki (JP); Asako KATAYAMA, Kawasaki (JP); Toshihiro KODAKA, Kawasaki (JP); Yuji MIZOBUCHI, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/954,397

(22) Filed: Dec. 12, 2007

(30) Foreign Application Priority Data
Dec. 19, 2006 (JP) 2006-340927
Jun. 19, 2007 (JP) 2007-161665

(51) Int. Cl. G06F 7/00; G06F 17/30

(52) U.S. Cl. 707/100; 707/E17.005

(57) ABSTRACT

A test data registration method is to register data used for a test of an application using a database into said database by using a data registration application. This method include: obtaining data concerning a test condition; generating an input candidate value for the data registration application based on the data concerning the test condition and reverse specification data, which defines a reverse processing of the data registration application and is identified from specification data of the data registration application; and inputting the input candidate value into the data registration application to carry out a registration processing to the database.

### TECHNICAL FIELD OF THE INVENTION

This invention relates to a technique to register data used in a test for an application program using a database into the database.

### BACKGROUND OF THE INVENTION

Conventionally, following two methods for preparing a database when a test for an application program using the database is carried out exist.

### (A) A Method for Directly Registering Data into the Database

In a method for directly registering data into the database by using a Structured Query Language (SQL) or the like, an appropriate value must be set into each column based on a schema. In addition, in order to maintain a data association on the business, it is necessary to separately register associated data into other databases, appropriately. Because a lot of jobs are required to set appropriate values into each column, it is very difficult to carry out settings of data by human hands while maintaining consistency on the business.

For that purpose, for example, JP-A2000-20529 discloses a technique to automatically generate test data by providing a data generation rule and coupling information for schema information held in a database. Specifically, a data warehouse test data generation apparatus has a database; database access means of the database; data generation information storage means for holding data generation information, which is generated by inputting the data generation rule and the coupling information into the schema information of the database; data generation information registration means for inputting association information of the data generation rule and the coupling information; data generation means for generating test data by the schema information and the association information; data generation activation means for inputting instructions and parameters; and a data memory of a work area for the test data generation. However, this publication does not presuppose a case where a registration application for registering data into the database is used.

In addition, JP-A-2001-256076 discloses a test data generation technique for easily and appropriately generating test data suitable for an actual environment. Specifically, when a user sets parameters for the test data generation, a test data generation apparatus connects with an existing database, and obtains data storage information in the existing database. Next, while referring to the data storage information, it reads out records stored in a table of the existing database, and calculates characteristic of column data, and after disconnecting with the existing database, it generates the test data by using the characteristic of the existing database. When the test data is generated, it connects with a database to be developed, and stores records of the generated test data into the database to be developed. Therefore, by using data stored in the existing database, which is actually operating, it is possible to generate dummy test data much according to the actual state, and appropriately carry out tuning of the database. However, when data matching with the purpose of the test for the application program to be tested is not registered in the database, the test for the application program is not appropriately carried out. Such a point is not considered in this publication.

### (B) A Registration Method Using a Registration Application Program

For the database used by the application program to be test, there is a case where a registration application program is prepared to carry out data registration into the database so as to maintain the consistency on the business. When such a registration application program exists, there is no need for the user to mention a point of maintaining the consistency on the business. However, it cannot be easily understood that what data should be inputted into the registration application in order to carry out an appropriate test of the application program to be tested.

Thus, in the conventional arts, it is impossible to automatically register the test data suitable for the purpose of the test in such an environment that data is registered into the database by using the registration application program.

### SUMMARY OF THE INVENTION

Therefore, an object of this invention is to provide a technique to automatically register the test data suitable for the purpose of the test into the database in such an environment that data is registered into the database by the registration application program.

In addition, another object of this invention is to provide a technique to generate data to carry out the test of the application program to be tested, without lack of the test items.

A test data registration method according to this invention is a method for registering data used for a test of an application using a database into the database by using a data registration application, including: obtaining data concerning a test condition, and storing the data concerning the test condition into a test condition data storage; generating an input candidate value for the data registration application based on the data concerning the test condition, which is stored in the test condition data storage, and reverse specification data, which defines a reverse processing of the data registration application and is identified from specification data of the data registration application, and storing the input candidate value into a storage device, and inputting the input candidate value (e.g. as an input message) stored in the storage device into the data registration application to carry out a registration processing to the database.

By carrying out such a processing, data suitable for the purpose of the test is registered into the database through the data registration application while maintaining the consistency on the business. That is, data suitable for the test of the application to be tested is stored into the database.

Incidentally, the aforementioned generating may include: generating an initial input candidate value (e.g. an initial candidate value in an embodiment) for the data registration application according to the data concerning the test condition, which is stored in the test condition data storage, and generating the input candidate value from the initial input candidate value by using the reverse specification data defining the reverse processing of the data registration application. Thus, data suitable for the purpose of the test is properly registered into the database.

Furthermore, the generating the initial input candidate value and the generating the input candidate value may be carried out for each data item for which the data concerning the test condition is defined.

Moreover, the aforementioned generating the initial input candidate value may include, when the initial input candidate value cannot be directly identified from the data concerning the test condition, identifying an input representative value stored in an input representative value data storage as the initial input candidate value. For example, when the data concerning the test condition defines a test condition that “A” is not included, a value other than “A” is obtained from the input representative values.

Furthermore, the aforementioned generating may include identifying an input representative value stored in an input representative value data storage, as the initial candidate value, for a data item for which data concerning the test condition is not defined. This is because, for the data item for which the data concerning the test condition is not defined, an arbitrary value can be set.

In addition, this invention may further include generating the reverse specification data defining a reverse processing of the data registration application from the specification data of the data registration application.

Incidentally, the aforementioned generating the reverse specification data may include: changing an operation in a data input or data check within the specification data of the data registration application to a reverse operation; and interchanging an input item and an output item in the data input or data check within the specification data of the data registration application. Thus, the appropriate reverse specification data defining a reverse processing is generated.

Moreover, the aforementioned generating may further include: generating a second initial input candidate value for the data registration application from a processing logic included in the specification data of the data registration application, which is stored in a data registration application specification data storage, for a data item for which the initial input candidate value cannot be identified from the data concerning the test condition; and generating the input candidate value from the second initial input candidate value by using the reverse specification data defining the reverse processing of the data registration application. Thus, variations of the input candidate values can be increased and the leakage of the test items can be prevented.

Moreover, the aforementioned inputting may include generating a plurality of messages by combining the input candidate values of each data item. Thus, plural test records can be appropriately registered into the database.

Furthermore, the aforementioned generating may further include: generating a third initial input candidate value for the data registration application from a processing logic included in the specification data of the application using the database, which is stored in the specification data storage, for an data item for which the initial input candidate value cannot be identified from the data concerning the test condition; and generating the input candidate value from the third initial input candidate value by using second reverse specification data defining a reverse processing of the application using the database and the reverse specification data defining the reverse processing of the data registration application. Thus, variations of the input candidate values can be further increased, and the leakage of the test items can be prevented.

In addition, this invention may further include extracting the input candidate value from data, which has been already registered into the database. It is possible to further increase the variations of the input candidate values.

Furthermore, this invention may further include generating new data concerning the test condition from the data concerning the test data and records registered in the database by the inputting. Thus, it is possible to cause the test executor to carry out the test without leakage of the test items.

Incidentally, it is possible to create a program for causing a computer to execute this method. The program is stored into a storage medium or a storage device such as, for example, a flexible disk, a CD-ROM, a magneto-optical disk, a semiconductor memory, or a hard disk. In addition, the program may be distributed as digital signals over a network in some cases. Data under processing is temporarily stored in the storage device such as a computer memory.

### BRIEF DESCRIPTION OF THE DRAWINGS

FIG. 1 is a diagram showing an outline of a system, which is a premise of a first embodiment of this invention;

FIG. 2 is a functional block diagram of a system relating to the first embodiment of this invention;

FIG. 3 is a diagram showing an example of XML specification description of a registration application;

FIG. 4 is a diagram showing an example of the XML specification description of a reverse processing of the registration application;

FIG. 5 is a diagram showing an example of the XML specification description of a test target application;

FIG. 6 is a diagram showing a main processing flow in the first embodiment of this invention;

FIG. 7 is a diagram showing test case data of a test number 1;

FIG. 8 is a diagram showing test case data of a test number 2;

FIG. 9 is a diagram showing examples of input representative values;

FIG. 10 is a diagram showing a second portion of the main processing flow in the first embodiment of this invention;

FIG. 11 is a diagram showing examples of input messages;

FIG. 12 is a diagram showing an example of data registered in a DB;

FIG. 13 is a diagram showing an example of a case where plural DBs are needed;

FIG. 14 is a diagram showing a processing flow of a reverse specification data generation processing;

FIG. 15 is a diagram showing a processing flow of an intra-section processing;

FIG. 16 is a diagram showing a second portion of the processing flow of the intra-section processing;

FIG. 17 is a diagram showing an outline of a system, which is a premise of a second embodiment of this invention;

FIG. 18A is a diagram showing an example of an order table, and FIG. 18B is a diagram showing an example of an amount table;

FIG. 19 is a functional block diagram of a system relating to second to fourth embodiments of this invention;

FIG. 20 is a diagram showing an example of specification data (copy information) of a data registration application;

FIG. 21 is a diagram showing an example of specification data (processing logic) of the data registration application;

FIG. 22 is a schematic diagram of a processing logic in the specification data of the data registration application;

FIG. 23 is a diagram showing a main processing flow in the second embodiment of this invention;

FIG. 24 is a diagram showing an example of the test case data;

FIG. 25 is a diagram showing examples of the input representative value;

FIG. 26 is a diagram showing an example of the reverse specification data;

FIG. 27 is a diagram showing a processing flow of a first input candidate value extraction processing;

FIG. 28 is a diagram showing a rule to identify the initial candidate value from the processing flow and the like;

FIG. 29 is a diagram showing an example of a processing result of the first input candidate value extraction processing;

FIG. 30 is a diagram showing a processing flow of a second input candidate value extraction processing;

FIG. 31 is a diagram showing an example of processing logic initially extracted in the second input candidate value extraction processing;

FIG. 32 is a diagram showing an example of processing logic extracted in the second input candidate value extraction processing;

FIG. 33 is a diagram showing a processing result at a first stage of the second input candidate value extraction processing;

FIG. 34 is a diagram showing a processing result at a second stage of the second input candidate value extraction processing;

FIG. 35 is a diagram showing a processing result at a third stage of the second input candidate value extraction processing;

FIG. 36 is a diagram showing a processing result when the input candidate value is identified by using the input representative value;

FIG. 37 is a diagram showing variations of the generated input messages;

FIG. 38 is a diagram showing an example of data registered in the order table;

FIG. 39 is a diagram showing examples of the test cases expanded in the second embodiment;

FIG. 40 is a diagram showing a processing flow of a third input candidate value extraction processing;

FIG. 41 is a schematic diagram of processing logic of the test target application;

FIG. 42 is a schematic diagram of the reverse specification of the test target application;

FIG. 43 is a diagram schematically showing a processing of the third embodiment of this invention;

FIG. 44 is a diagram showing variations of the input candidate values as a processing result in the third embodiment of this invention;

FIG. 45 is a schematic diagram of the copy information to explain the fourth embodiment of this invention;

FIG. 46 is a schematic diagram to explain the fourth embodiment of this invention;

FIG. 47 is a functional block diagram of a computer;

FIG. 48 is a diagram showing an outline of a system, which uses the XML data specification description;

FIG. 49 is a diagram showing the constitution of the XML specification description;

FIG. 50 is diagram showing an example of the XML data specification description;

FIG. 51 is a diagram showing a list of object expressions, which can be described;

FIG. 52 is a diagram showing a list of operators, which can be designated in op attribute;

FIG. 53 is a diagram showing a list of methods to be applied to property of function attribute of value element; and

FIG. 54 is a diagram showing a description method of the regular expression.

### DETAILED DESCRIPTION OF THE PREFERRED EMBODIMENTS

### Embodiment 1

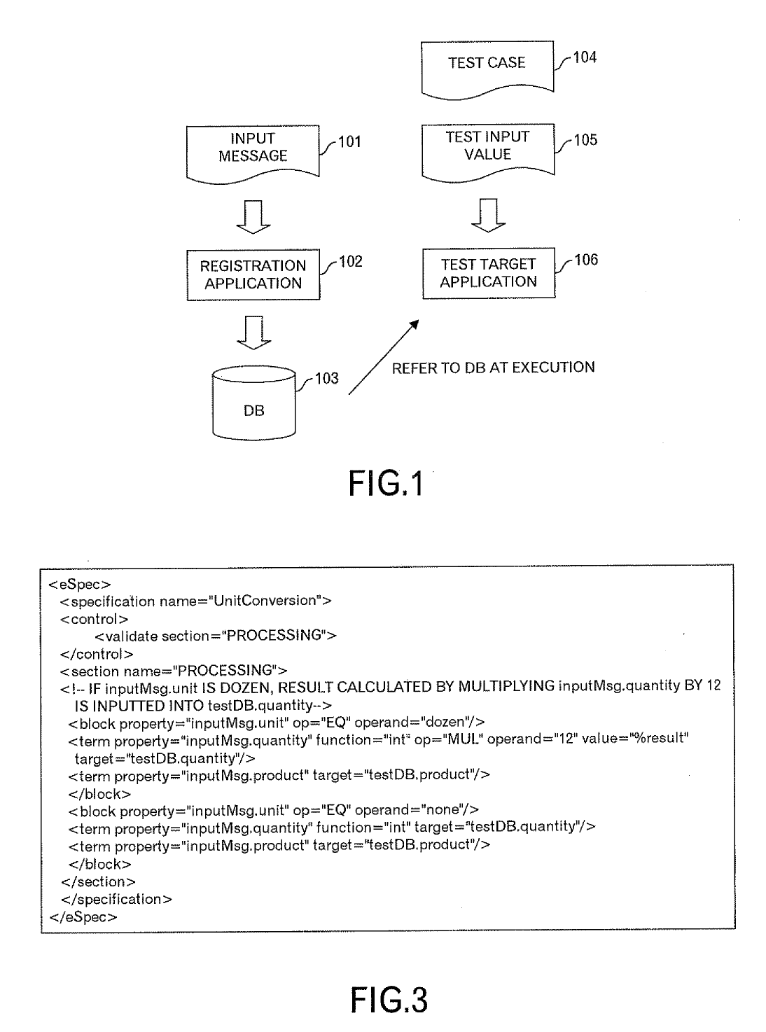

First, a system outline that is a premise in a first embodiment of this invention will be explained by using FIG. 1. A test target application 106 is configured so as to refer to a database (DB) 103 during the execution. For data registration to this DB 103, a registration application 102 is used, and the registration application 102 registers data into the DB 103 in response to an input message 101 for the registration application 102. In addition, when a test of the test target application 106 is carried out, a test case 104 defining the test condition and test input value 105 for the test case 104 is prepared, and the test input value 105 is inputted into the test target application 106. By doing so, the test of the test target application 106 is carried out.

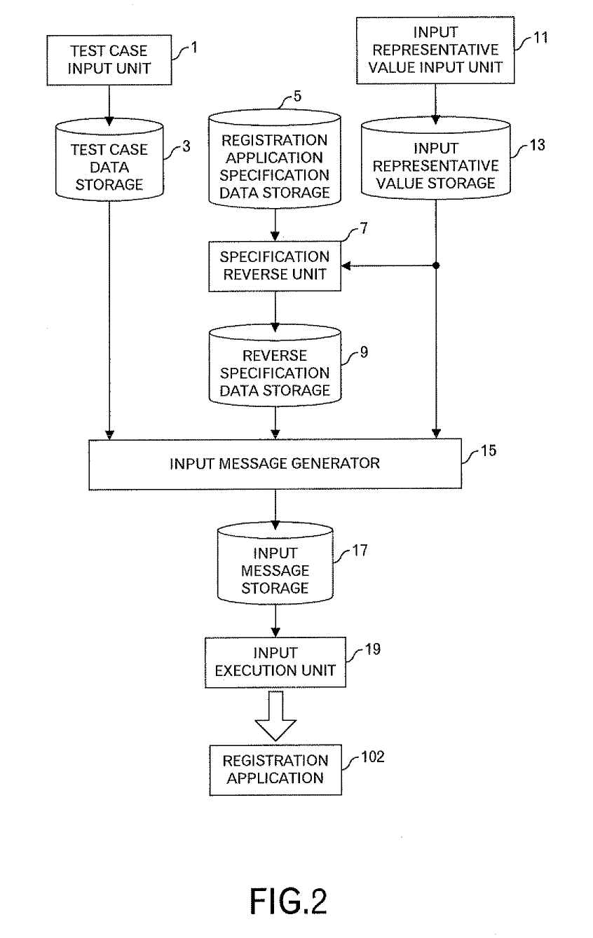

Under such a premise, in order to store data according to the test cases 104, it is necessary to appropriately generate an input message 101. A test data registration apparatus to appropriately generate the input message 101 will be explained by using FIGS. 2 to 16.

The test data registration apparatus according to this embodiment has a test case input unit 1 to input data concerning the test case; a test case data storage 3 storing data concerning the test case, which was inputted by the test case input unit 1; an input representative value input unit 11 to input the input representative value; an input representative value storage 13 storing the input representative values inputted by the input representative value input unit 11; a registration application specification data storage 5 storing specification data of the registration application 102; a specification reverse unit 7 that carries out a processing to generate reverse specification data for carrying out a reverse processing of the registration application 102 by using data stored in the registration application specification data storage 5 and the input representative value storage 13; a reverse specification data storage 9 storing the reverse specification data that is a processing result of the specification reverse unit 7; an input message generator 15 that carries out a processing to generate an input message for the registration application 102 by using data stored in the test case data storage 3, the reverse specification data storage 9 and the input representative value storage 13; an input message storage 17 storing the input messages generated by the input message generator 15; and an input execution unit 19 that carries out a processing to input the input messages stored in the input message storage 17 into the registration application 102.

Next, an example of data stored in the registration application specification data storage 5 will be shown in FIG. 3. Incidentally, an input message the registration application 102 in this embodiment accepts includes an item set including a product name, a quantity and a unit. In addition, the registration application 102 registers the product and the quantity, which are included in the input message, as one record, into the DB 103. At that time, when the unit in the input message is “none”, the quantity in the input message is registered as an integer, and when the unit is “dozen”, an integer calculated by multiplying the quantity in the input message by 12 is registered as its quantity. The specifications of the registration application 102 that carries out such a processing is data as shown in FIG. 3, when the specifications are described according to an XML data specification description method explained in an appendix in this specification.

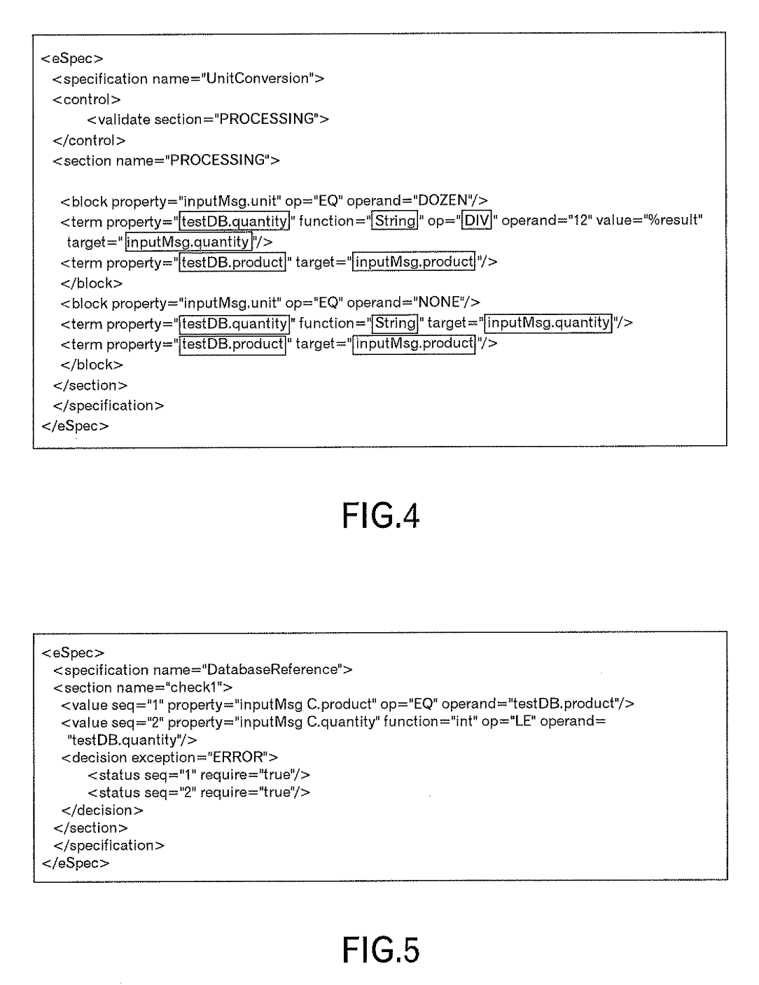

The specification reverse unit 7 carries out a processing, which will be explained in detail later, to generate the reverse specification data to carry out the reverse processing of the registration application 102, and stores the reverse specification data into the reverse specification data storage 9. An example of the reverse specification data corresponding to the specification data shown in FIG. 3 is shown in FIG. 4. Portions surrounded by a square in FIG. 4 are portions, which are substantially changed from FIG. 3. Specifically, “inputMsg.quantity”, which was an input, becomes an output, and “testDB.quantity”, which was an output, becomes an input. Furthermore, a value (i.e. method) of a function attribute is changed from “int” to “String”. Moreover, a value of an op attribute is changed from “MUL” (i.e. multiplication) to “DIV” (i.e. division). In addition, “inputMsg.product”, which was an input, becomes an output, and “testDB.product”, which was an output, becomes an input. Incidentally, the testDB means the DB 103.

Specific contents of FIG. 4 are as follows:

(a) inputMsg.product=testDB.product
(b) if inputMsg.unit is “none”, inputMsg.qunatity=testDB.quantity
(c) if inputMsg.unit is “dozen”, inputMsg.quantity=testDB.quantity/12

More specifically, the product of the input message is the product of the testDB. When the unit of the input message is “dozen”, a value calculated by “testDB.quantity”/12 becomes the quantity of the input message. When the unit is “none”, the testDB.quantity is the quantity of the input message.

Although an example that the reverse specification data is automatically generated by the specification reverse unit 7 is shown in the embodiment, the user may prepare the reverse specification data.

Incidentally, it is assumed that the test target application 106 is a program that carries out a following processing.

(a) An input message for the test target application 106 has data items including a product name and a quantity.
(b) If the product in the input message does not exist in the DB 103, an error is outputted.
(c) If the quantity corresponding to the product in the input message is greater than the quantity of the same product in the DB 103, an error is outputted.

The specifications of such a program can be described as shown in FIG. 5, for example, by using the same XML data specification description method as that of FIG. 3.

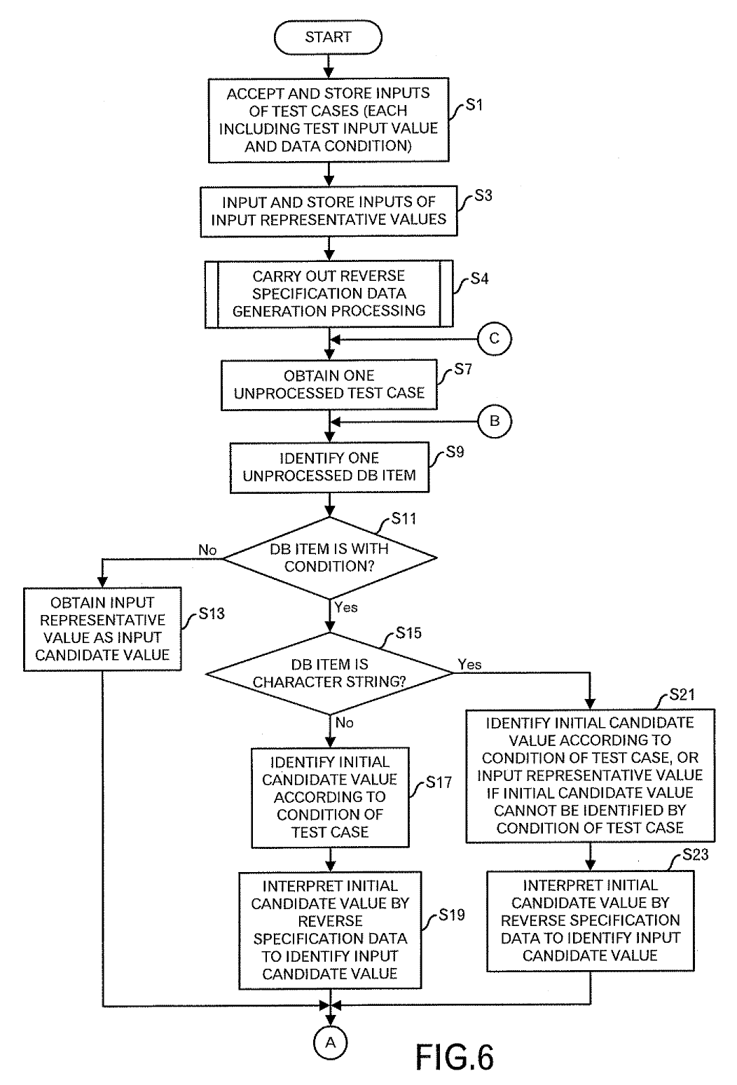

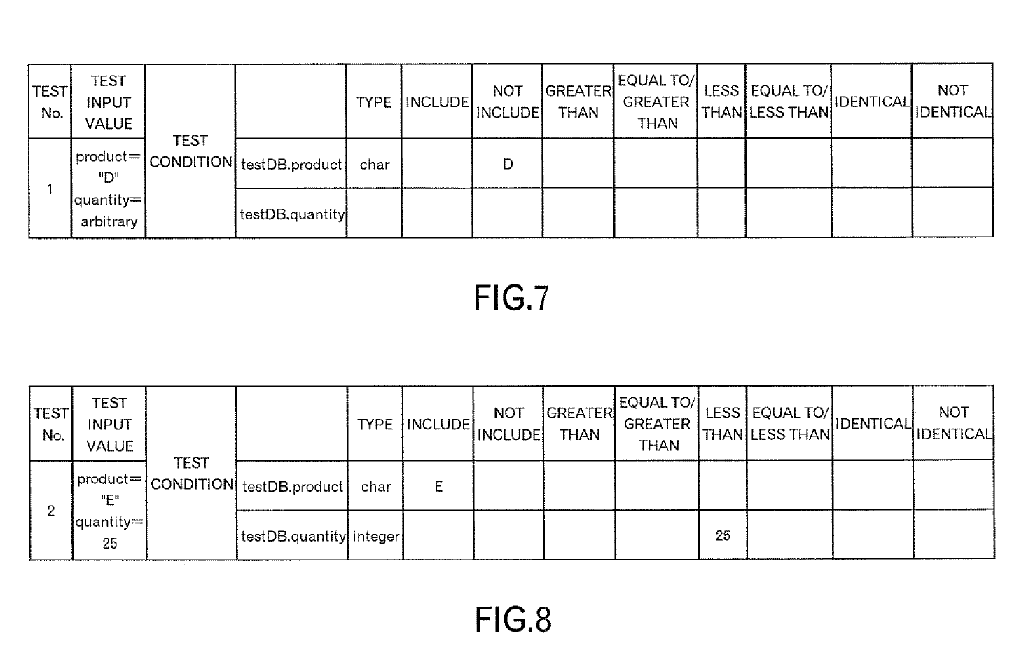

Next, a processing flow of the test data registration apparatus shown in FIG. 2 will be explained by using FIGS. 6 to 16. First, the test case input unit 1 prompts the user to input a test input value and a test condition, accepts inputs of the test input value and the test condition from the user, and stores the inputted data into the test case data storage 3 (step S1). For example, data as shown in FIG. 7 is stored into the test case data storage 3. In the example of FIG. 7, in a case of the test number “1”, a case where the product name relating to the input message does not exist in the DB 103 is tested. In such a case, as the test number “1”, “product=“D”” and “quantity=arbitrary” are set as the test input values. In addition, as the test condition, a condition that testDB.product (char type) does not include “D” is set. As for the test condition, “include a value”, “not include a value, greater than”, “equal to or greater than”, “less than”, “equal to or less than”, “identical”, “not identical” or the like can be set. In the example of FIG. 7, because the value is arbitrary, the test condition is not set.

In addition, in an example of FIG. 8, in a case of the test number “2”, a case where the quantity of the products relating to the input message is greater than the quantity of the products in the DB 103 is tested. In such a case, as the test number “2”, “product=“E”” and “quantity=25” are set as the test input value. Moreover, as the test condition, a condition that testDB.product (char type) includes “E” and a condition that testDB.quantity (integer type) is less than “25” are set.

The user inputs the test input values and the test conditions by the test case input unit 1.

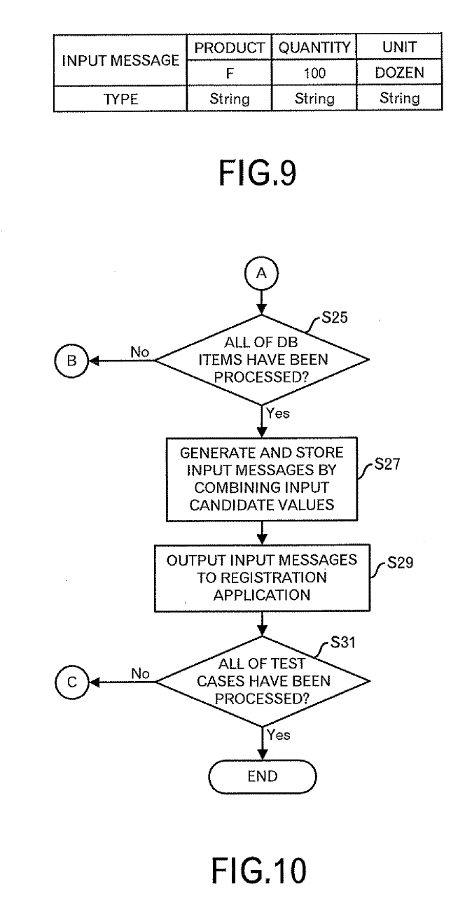

Next, the input representative value input unit 11 prompts the user to input the input representative values, accepts the inputs of the input representative values from the user, and stores the input representative values into the input representative value storage 13 (step S3). For example, data as shown in FIG. 9 is inputted and stored into the input representative value storage 13. In an example of FIG. 9, a value “F” of an item “product” included in the input message and a type “String”, a value “100” of an item “quantity” and a type “String”, and a value “dozen” of an item “unit” and a type “String” are inputted and stored.

Then, the specification reverse unit 7 carries out a generation processing of the reverse specification data by using data stored in the registration application specification data storage 5 and the input representative value storage 13 (step S4). This processing will be explained in detail later. As a result, data as shown in FIG. 4 is stored in the reverse specification data storage 9. In addition, when the reverse specification data is generated by the human being, this step is skipped.

Then, the input message generator 15 refers to the test case data storage 3 to obtain data of an unprocessed test case (step S7). In addition, the input message generator 15 refers to the input representative value storage 13, for example, to identify an unprocessed DB item (step S9). As for the unprocessed DB item, a DB item defined as a condition in the reverse specification data stored in the reverse specification data storage 9, for example, is preferentially identified. In the example of FIG. 4, because “unit” is defined as a condition, “unit” is processed firstly.

After that, the input message generator 15 judges, based on data of the test case obtained at the step S7, whether or not a condition is set to the DB item identified at the step S9 (step S11). For example, in a case of the test number “1”, because a condition is set only to testDB.product, the input message generator 15 can judge that a condition is set to the product and any condition is not set to the other DB items. In addition, in a case of the test number “2”, because a condition is attached to testDB.product and testDB.quantity, the input message generator 15 judges that a condition is set to these, and any condition is not set to the DB item “unit”.

Here, when it is judged that any condition is not set to the DB item identified at the step S9, the input message generator 15 obtains an input representative value of that DB item as an input candidate value from the input representative value storage 13, and stores the input candidate value into a storage device such as a main memory (step S13). Then, the processing shifts to a processing of FIG. 10 through a terminal A.

For example, in the test number “1” or “2”, when the DB item “unit” is processed, “dozen”, which is an input representative value of that DB item, is identified as the input candidate value.

For example, in a case of the test number “1”, when the DB item “quantity” is processed, because any test condition is not set, “100”, which is an input representative value of that DB item is identified as the input candidate value.

On the other hand, when it is judged that a condition is set to the DB item identified at the step S9, the input message generator 15 judges whether or not the DB item identified at the step S9 is a character string (step S15). When it is judged that the DB item identified at the step S9 is a character string, the input message generator 15 identifies an initial candidate value according to the test condition of the test case identified at the step S7 or an input representative value of that DB item when the initial candidate value cannot be identified by the test condition (step S21).

Then, the input message generator 15 interprets the initial candidate value by the reverse specification data stored in the reverse specification data storage 9 to identify the input candidate value (step S23). After that, the processing shifts to a processing of FIG. 10 through the terminal A.

For example, in a case of the test number “1”, as shown in FIG. 7, a condition that “D”, which is a test condition, is not included is set to the DB item “product” whose type is the character string. However, because the product name other than “D” cannot be identified only by this test condition, “F”, which is an input representative value of that DB item, is identified and is adopted as an initial candidate value. In addition, when the aforementioned reverse specification data is applied, “F” itself is adopted as the input candidate value.

In addition, in a case of the test number “2”, because a condition that “E”, which is a test condition, is included is set to the DB item “product”, as shown in FIG. 8, “E” is identified as an initial candidate value from the test condition. Moreover, when the aforementioned reverse specification data is applied, “E” itself is adopted as an input candidate value.

Furthermore, when it is judged that the DB item is not a character string, the input message generator 15 identifies an initial candidate value according to the test condition of the test case obtained at the step S7 (step S17). Then, the input message generator 15 interprets the initial candidate value by the reverse specification data stored in the reverse specification data storage 9 to identify the input candidate value (step S19). After that, the processing shifts to the processing of FIG. 10 through the terminal A.

For example, in a case of the test number “2”, because a condition of an integer less than “25”, which is a test condition, as shown in FIG. 8, is set for the DB item “quantity”, which is a numeral value (int), “24” is set to the initial candidate value based on the test condition. Incidentally, other value may be adopted if the integer is equal to or less than “24”. In addition, when the aforementioned reverse specification data is applied, “2”, which is calculated by 24/12, is identified as an input candidate value, because “dozen” is identified as the unit.

Shifting to the explanation of the processing of FIG. 10, the input message generator 15 judges whether or not all DB items have been processed (step S25). When there is an unprocessed DB item, the processing returns to the step S9 through a terminal B.

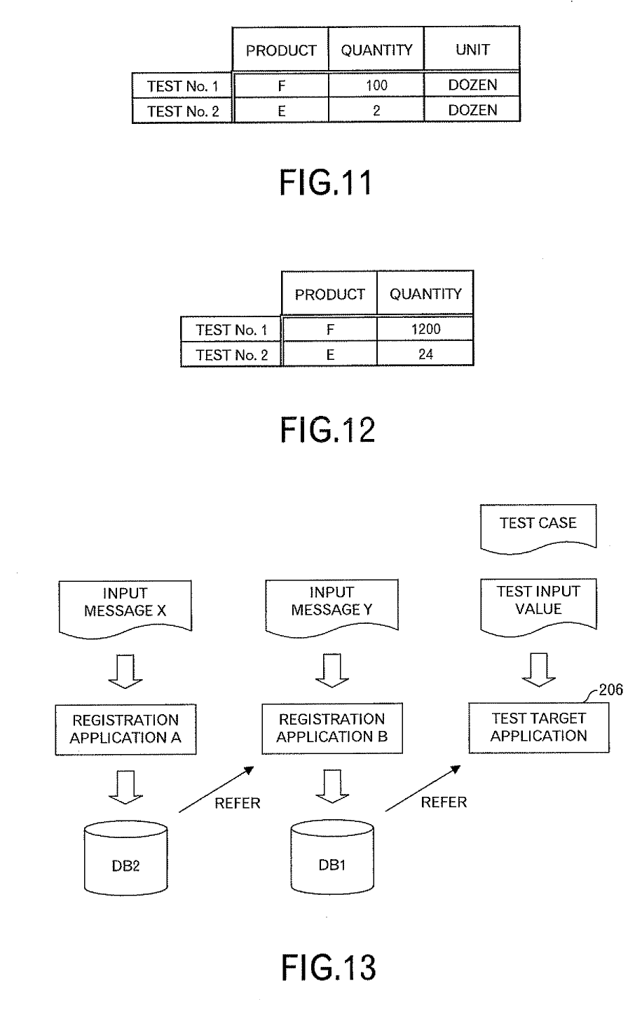

On the other hand, when all DB items have been processed, the input message generator 15 generates input messages by combining the input candidate values, and stores the input messages into the input message storage 17 (step S27). For example, data as shown in FIG. 11 is stored. In an example of FIG. 11, for each test number, the product, quantity and unit are stored. As described above, in the case of the test number “1”, the product “F”, quantity “100” and unit “dozen” are identified as an input message. In the case of the test number “2”, the product “E”, quantity “2” and unit “dozen” are identified as an input message.

Then, the input execution unit 19 outputs the input messages stored in the input message storage 17 to the registration application 102 (step S29). Then, the registration application 102 carries out a processing according to the specification data stored in the registration application specification data storage 5 to register data into the DB 103. When the input messages as shown in FIG. 11 are outputted to the registration application 102, data as shown in FIG. 12 is registered into the DB 103. That is, in the case of the test number “1”, the product “F” and quantity “1200” (=100*12) are registered, and in the case of the test number “2”, the product “E” and quantity “24” (=2*12) are registered.

After that, the input message generator 15 judges whether or not all of the test cases have been processed (step S31). When there is an unprocessed test case, the processing returns to the step S8 in FIG. 6 through a terminal C. On the other hand, when all of the test cases have been processed, the processing ends.

By carrying out the processing as described above, data is registered through the registration application 102 into the DB 103 in such a form that the data conforms to each test case. Incidentally, because the registration application 102 is used, the data consistency in the DB 103 does not have any problems. Therefore, the test environment preparation for the test target application 106 becomes efficient.

Incidentally, data of the test cases may be registered in the input message storage 17 in association with the data of the input messages. Then, it is possible to hold data concerning what input message should be outputted to the registration application 102 in what case, and in a case where the same test is carried out again, the input message stored in the input message storage 17 can be reused.

Incidentally, the system outline, which is a premise of this embodiment and shown in FIG. 1, is a mere example, and a system as shown in FIG. 13 may be adopted. Specifically, because the test target application 206 refers to the DB 1, the test data should be registered in the DB 1. However, there is a case where the registration application B for the DB 1 further refers to another DB 2 other than the DB 1, and a registration application A for the DB 2 exists, separately. In such a case, an input message X to register data into the DB 2 is generated to register data into the DB 2 by the registration application A. Furthermore, an input message Y to register data into the DB 1 is generated to register data into the DB 1 by the registration application B. Thus, the DBs for the test are recursively constructed to carry out the test of the test target application 206. Incidentally, the aforementioned method can be applied to the generation of the input messages X and Y.

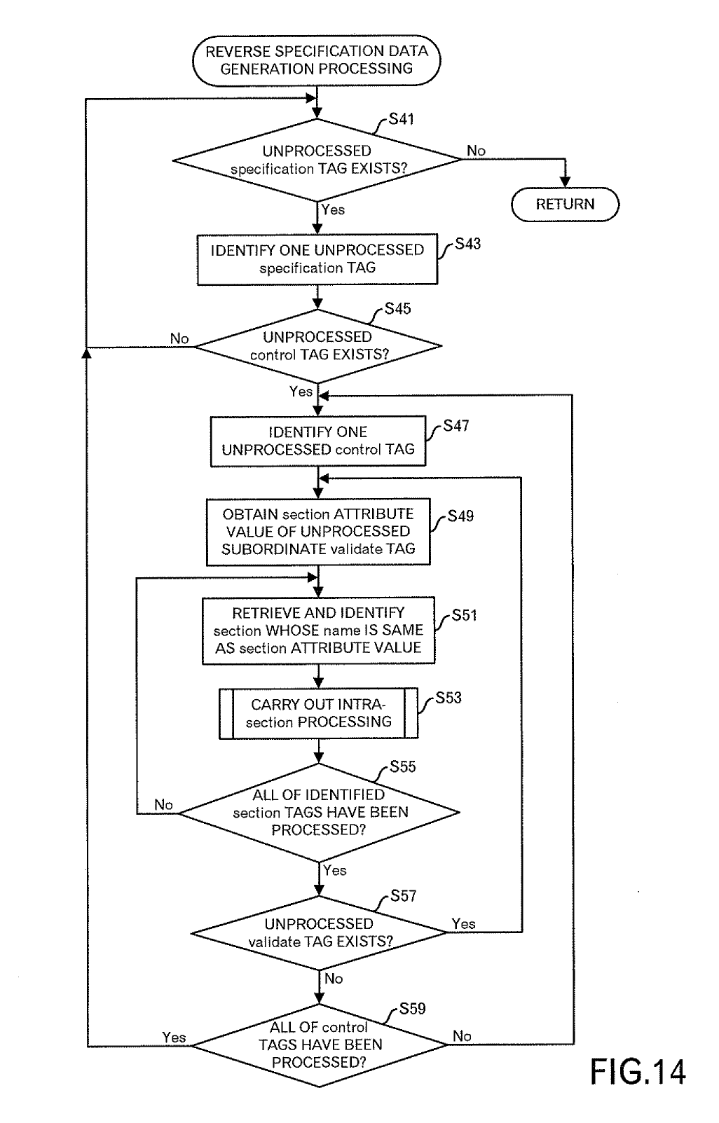

Next, the reverse specification generation processing will be explained by using FIGS. 14 to 16. Incidentally, the specification description for the registration application 102 by XML has two purposes. That is, those are (1) check and error detection of input values and (2) operation and storage of the input values. In this embodiment, obtaining complete reverse specification of the specification is not the purpose of this embodiment, and the purpose is to analyze the operation and storage of the input values by directing the attention to data.

Then, the specification reverse unit 7 starts searching from an eSpec tag, searches the specification for a Specification tag, which defines a unit of the specification description, and judges whether or not an unprocessed Specification tag exists (step S41). When the unprocessed Specification tag exits, the specification reverse unit 7 identifies one unprocessed Specification tag (step S43). On the other hand, when the unprocessed Specification tag does not exist, the processing returns to an original processing.

When the specification reverse unit 7 identifies the unprocessed Specification tag, the specification reverse unit 7 searches the specification for a Control tag under that Specification tag, and judges whether or not an unprocessed Control tag exists (step S45). When there is no unprocessed Control tag, the processing returns to the step S41. On the other hand, when there is an unprocessed Control tag, the specification reverse unit 7 identifies one unprocessed Control tag (step S47). Then, the specification reverse unit 7 obtains an attribute value of a section attribute in an unprocessed Validate tag under that Control tag (step S49). In the example of FIG. 3, “processing” is identified.

In addition, the specification reverse unit 7 searches the specification for a Section tag whose name is the same as the attribute value of the Section attribute, to identify the Section tag (step S51). In the example of FIG. 3, the pertinent Section tag exists in the sixth line. Then, the specification reverse unit 7 carries out an intra-Section processing for the identified Section tag (step S53). This intra-Section processing will be explained in detail later.

When the intra-Section processing ends, the specification reverse unit 7 judges whether or not all of the Section tags identified at the step S51 have been processed (step S55). When there is an unprocessed Section tag, the processing returns to the step S51. On the other hand, when all of the Section tags identified at the step S51 have been processed, the specification reverse unit 7 judges whether or not an unprocessed Validate tag exists (step S57). When the unprocessed Validate tag exists, the processing returns to the step S49. On the other hand, the specification reverse unit judges whether or not all of the Control tags have been processed (step S59). When all of the Control tags have been processed, the processing returns to the step S41. When there is an unprocessed control tag, the processing returns to the step S47.

By carrying out such a processing, it is possible to carry out a processing for necessary portions in the XML specification of the registration application 102 without any leakage.

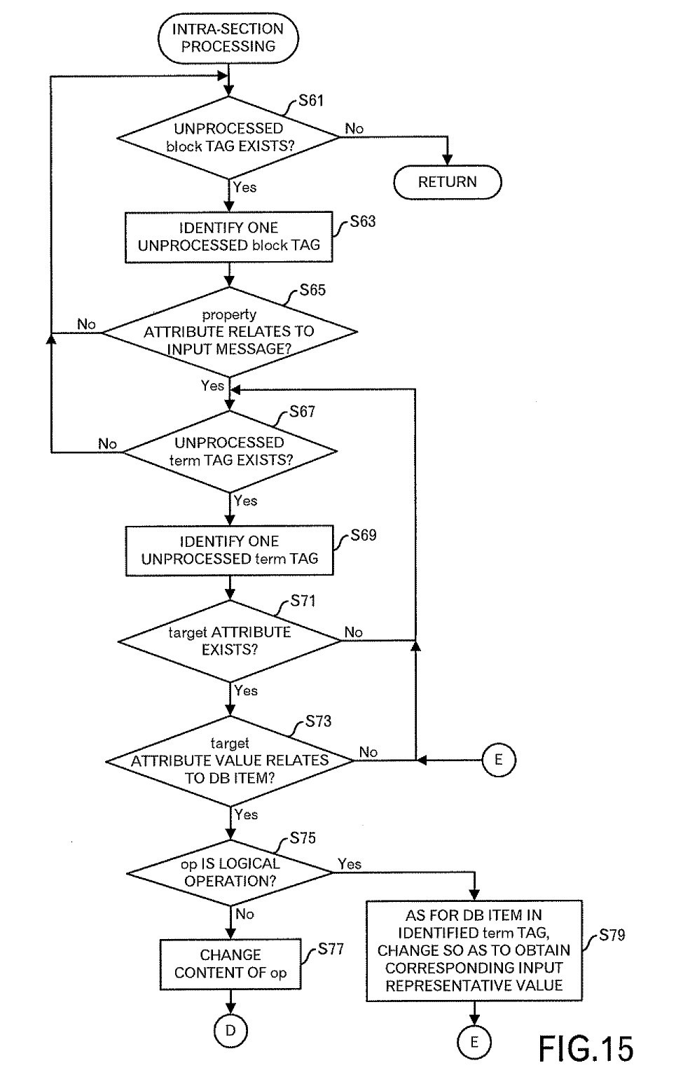

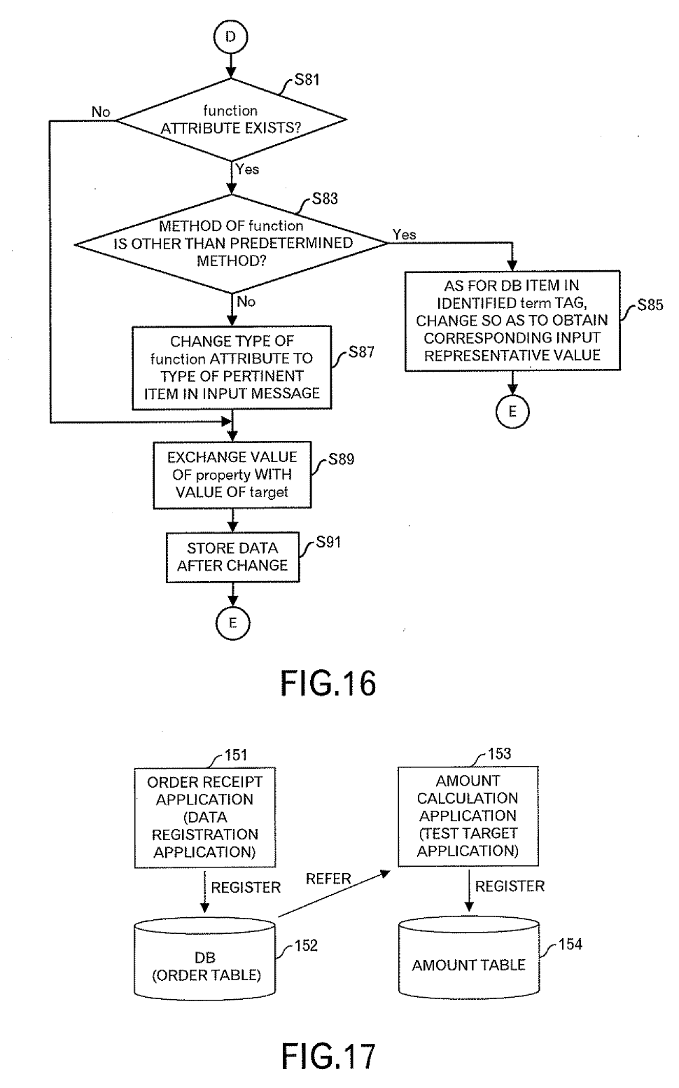

Next, the intra-Section processing will be explained by using FIGS. 15 and 16. Under a block tag, there is a case where a term tag, a value tag or a verify tag exists, and the value tag and verify tag correspond to a check processing of the input data, and do not have any relation to this embodiment. Only the term tag relates to this embodiment. Then, the specification reverse unit 7 searches the specification for the block tag, and judges whether or not there is an unprocessed block tag (step S61). When all of the block tags have been processed, the processing returns to the original processing. On the other hand, when there is an unprocessed block tag, the specification reverse unit 7 identifies one unprocessed block tag (step S63). Then, the specification reverse unit 7 judges whether or not the property attribute of that block tag is concerned with the input message (step S65). In the example of FIG. 3, because the block tag in the eighth line is identified, and the property attribute is “inputMsg.unit”, it is judged that it is concerned with the input message. When the property attribute is not concerned with the input message, the processing returns to the step S61. On the other hand, when the property attribute is concerned with the input message, the specification reverse unit 7 searches the specification under that block tag to judge whether or not there is an unprocessed term tag (step S67). When there is no unprocessed term tag, the processing returns to the step S61.

On the other hand, when there is an unprocessed term tag, the specification reverse unit 7 identifies the unprocessed term tag (step S69), and judges whether or not a target attribute exists (step S71). When the target attribute does not exist, the processing returns to the step S36, because it is a check processing. On the other hand, when there is a target attribute, the specification reverse unit 7 judges whether or not an attribute value of the target attribute is concerned with the DB item (step S73). In the example of the ninth and tenth lines in FIG. 3, because “target=testDB.quantity” is represented, it is understood that it is concerned with the DB item. When the attribute value of the target attribute is not concerned with the DB item, the processing returns to the step S67. On the other hand, when the attribute value of the target attribute is concerned with the DB item, the specification reverse unit 7 judges whether or not an op attribute represents a logical operation (step S75). When the op attribute represents the logical operation, because the reverse specification cannot be generated, the specification reverse unit 7 changes the attribute to a processing to obtain a corresponding input representative value for the DB item in the term tag identified at the step S69 (step S79). Then, the processing shifts to the step S67 through a terminal E.

On the other hand, when the op attribute does not represent the logical operation, the specification reverse unit 7 changes the value of the op attribute as follows (step S77). That is, “ADD” is changed to “SUB”, “SUB” is changed to “ADD”, “MUL” is changed to “DIV”, and “DIV” is changed to “MUL”. In a case of “EQ”, there is no change. In the case of the ninth and tenth lines in FIG. 3, “MUL” is changed to “DIV”.

Shifting to the processing of FIG. 17 through the terminal D, the specification reverse unit 7 judges whether or not a function attribute exists (step S81), and when there is no function attribute, the processing shifts to a step S89. When the function attribute exists, the specification reverse unit 7 judges whether or not a method of the function is other than predetermined methods (here, int, long, double, boolean and string) (step S83). When the method of the function is other than the predetermined methods, because the reverse specification cannot be identified, the specification reverse unit 7 changes the function attribute to a processing to obtain a corresponding input representative value for the DB item in the term tag identified at the step S69 (step S85). Then, the processing shifts to the step S67 through the terminal E.

On the other hand, when the method of the function is included in the predetermined methods, the specification reverse unit 7 converts the function attribute into a type of an item pertinent in the input message (step S87). Specifically, the function attribute is converted to a type of a pertinent item of the input representative value stored in the input representative value storage 13. In the case of the ninth and tenth lines in FIG. 3, because the method of the function attribute is “int”, and the type of the input representative value for the quantity is “String”, the function attribute is converted to “String”.

Then, the specification reverse unit 7 exchanges the value of the target attribute with the value of a property attribute (step S89). After that, the specification reverse unit 7 stores the data after the change into the reverse specification data storage 9 (step S91). Then, the processing returns to the step S67 through the terminal E.

By carrying out the aforementioned processing, the specification as shown in FIG. 3 is converted to the specification as shown in FIG. 4, and the specification as shown in FIG. 4 is stored into the reverse specification data storage 9.

According to the aforementioned processing, the ninth and tenth lines of FIG. 3 are converted to the eighth and ninth lines of FIG. 4, and the eleventh line of FIG. 3 is converted to the tenth line of FIG. 4. In addition, the fourteenth line of FIG. 3 is converted to the thirteenth line of FIG. 4, and the fifteenth line of FIG. 3 is converted to the fourteenth line of FIG. 4.

Although the first embodiment of this invention was described above, this invention is not limited to this embodiment. For example, the functional block diagram of FIG. 2 is a mere example, and it is not always identical with the actual program module configuration.

In addition, when the same result can be obtained, it is possible to exchange an order of the steps or execute the steps in parallel in the processing flow. For example, an order of the steps S3 and S1 can be exchanged.

In addition, as for the steps S65 and S73 in FIG. 15, there is a case where only Yes route should be selected according to the XML specification description.

### Embodiment 2

According to the first embodiment, although it becomes possible to automatically register data according to the test cases into the database, sufficient variations are not always registered into the database.

For example, by using a system (shown in FIG. 17) that data is registered by an order receipt application 151, which is a data registration application, into a DB 152 including an order table, and an amount calculation application 153, which is a test target application, refers to the order table to register data into an amount table 154, an example will be explained. Here, the order receipt application 151 registers a customer ID of a customer for an input message from the customer, and registers a sales ID of a sales staff from an input message from the sales staff. In addition, the amount calculation application 153 refers to the customer ID of the order table to calculate an amount by a corresponding unit price.

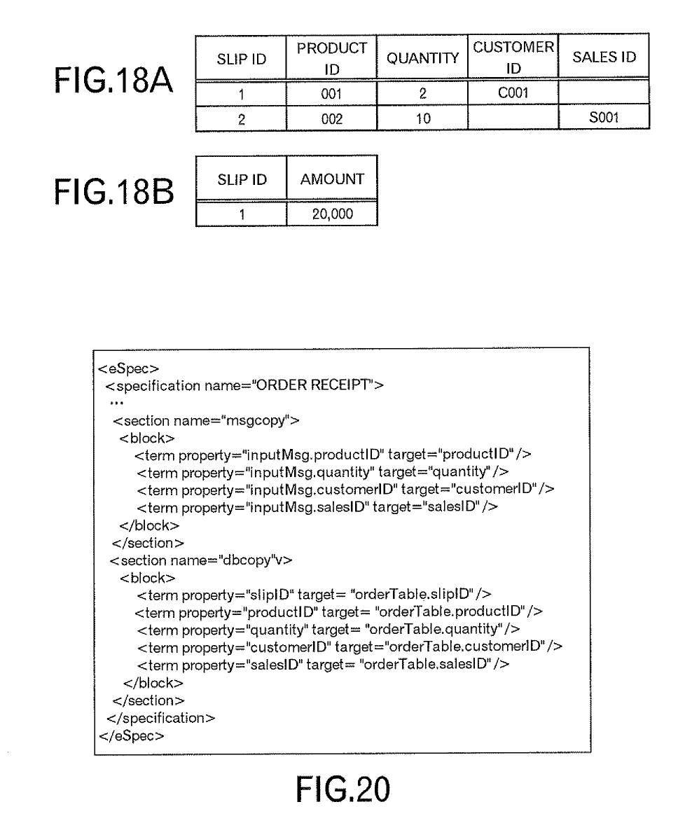

A failure occurred in the application is mainly based on gaps in the specification interpretation between developers. In the example of FIG. 17, a developer of the data registration application 151 assumes, as shown in FIG. 18A, a record whose slip ID is “1” and a record whose slip ID is “2” are registered. However, when a developer of the test target application develops the test target application without assuming a case where the customer ID is null, a failure may occur for the record whose slip ID is “1” although data as shown in FIG. 18B is registered into the amount table 154 for the record whose slip ID is “1” in FIG. 18A without any problem. In addition, any test case for the record whose slip ID is “2” is not prepared. Therefore, there is possibility that such a problem cannot be detected. In order to cope with such a problem, by enriching variations of data to be registered into the DB 152 through the data registration application 151 and adding the test cases, this embodiment prevents the leakage of the test items and the return back in the later stage of the development.

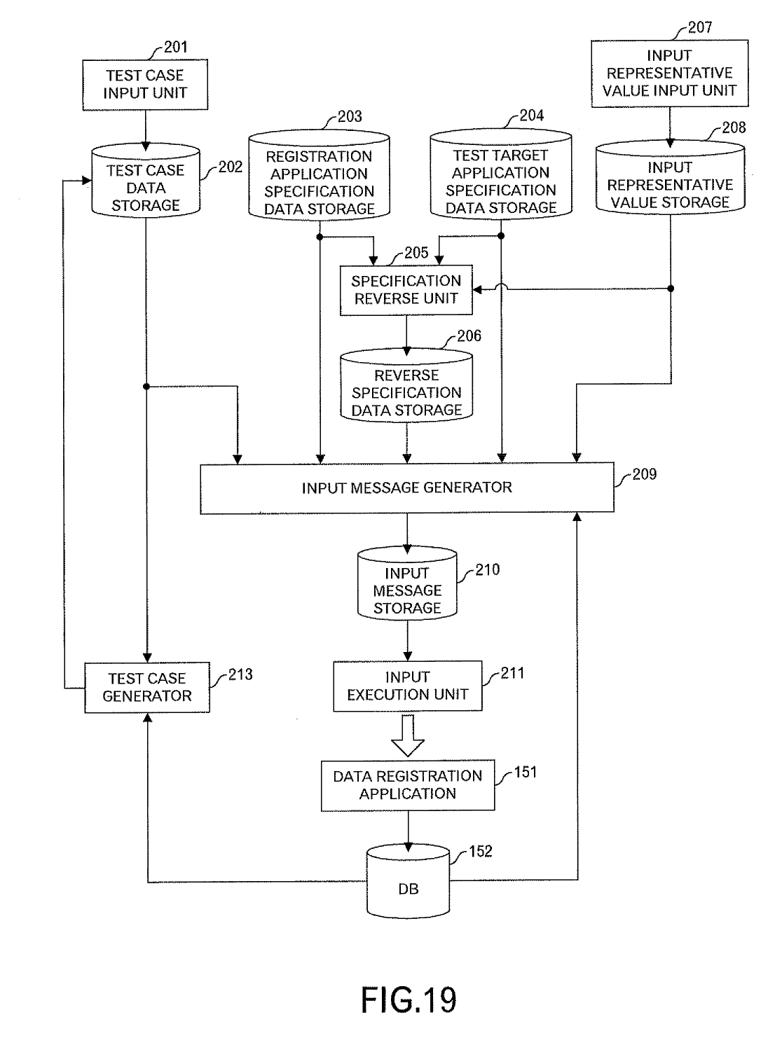

A functional block diagram of a test data registration apparatus in this embodiment will be shown in FIG. 19. Incidentally, necessary modules in third and fourth embodiments will be shown together. This test data registration apparatus includes a test case input unit 201; a test case data storage 202 storing test cases inputted by the test case input unit 201 and the like; a registration application specification data storage 203; a test target application specification data storage 204; an input representative value input unit 207; an input representative value storage 208 storing the input representative value inputted by the input representative value input unit 207; a specification reverse unit 205 that generates reverse specification data of the specification data stored in the registration application specification data storage 203 and the test target application specification data storage 204 by using data stored in the input representative value storage 208; a reverse specification data storage 206 storing the reverse specification data generated by the specification reverse unit 205; an input message generator 209 that generates an input message by using data stored in the test case data storage 202, the registration application specification data storage 203, the input representative value storage 208 and the reverse specification data storage 206 and according to circumstance, data stored in the test target application specification data storage 203 and the DB 152; an input message storage 210 storing the input messages generated by the input message generator 209; an input execution unit 211 that causes the data registration application 151 to carry out a registration processing of the input messages stored in the input message storage 210; and a test case generator 213 that generates additional test cases by using data stored in the test case data storage 202 and the DB 152.

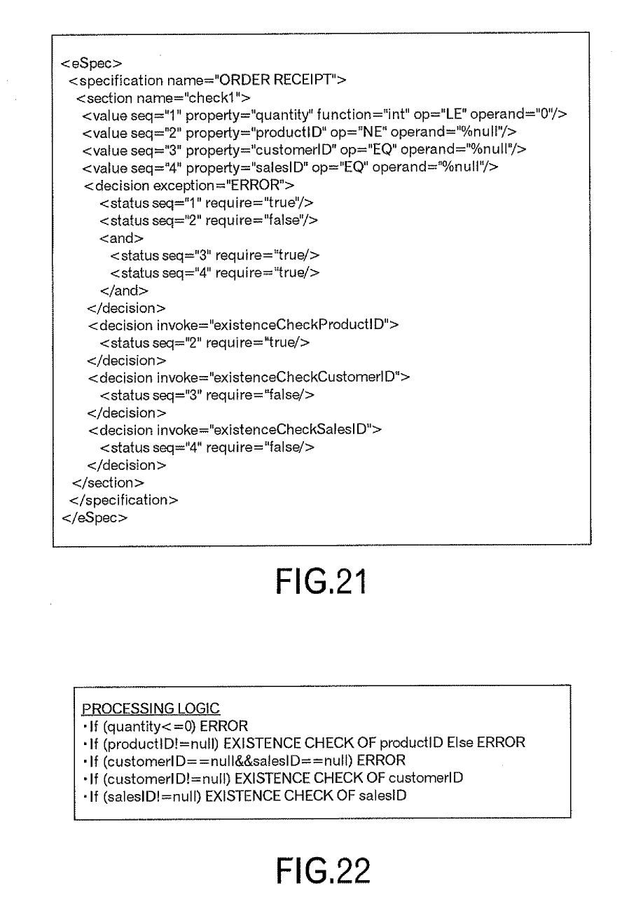

For example, data as shown in FIGS. 20 and 21 is stored in the registration application specification data storage 203. FIG. 20 shows copy information having a section (section name=“msgcopy”) to copy or convert data items in an input message (i.e. inputMsg) to corresponding data items in the data registration application 151 and a section (section name=“dbcopy”) to copy or convert data items in the data registration application 151 to corresponding data items in the order table of the DB 152. Incidentally, the description method is as shown in the XML specification description method described later. In the example of FIG. 20, an inputMsg.productID, inputMsg.quantity, inputMsg.customerID and inputMsg.salesID are copied to respective data items of the data registration application 151 as they are. Then, a slip ID, product ID, quantity, customer ID and sales ID in the data registration application 151 are respectively copied to an orderTable.slipID, orderTable.productID, orderTable.quantity, orderTable.customerID and orderTable.salesID as they are.

In addition, FIG. 21 shows a processing logic in the data registration application 151. In FIG. 21, four value tags whose attribute “seq” values are from “1” to “4” are provided, and in these value tags, conditional expressions are defined for the quantity, product ID, customer ID and sales ID. Specifically, quantity<=0, productID!=null, customeID=null and salesID=null are defined as the conditional expressions. Then, four decision tags are provided, and conditions for an error, existence check of the product ID, existence check of the customer ID and existence check of the sales ID are defined by using four expressions of the attribute seq. Specifically, a processing logic as shown in FIG. 22 is defined. However, even when “=” is defined in the conditional expression, “!=” is adopted in the conditional expression in FIG. 22 when a logical condition in the decision tag is “false”, and even when “!=” is defined in the conditional expression, “=” is adopted in the conditional expression in FIG. 22 when a logical condition in the decision tag is “false”.

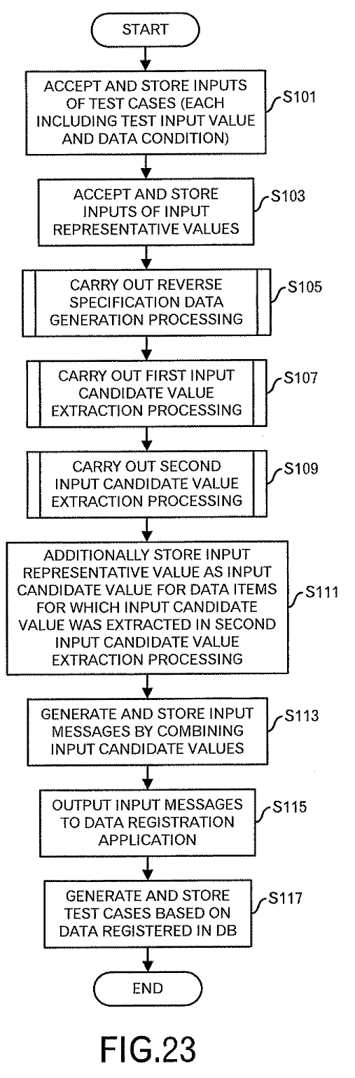

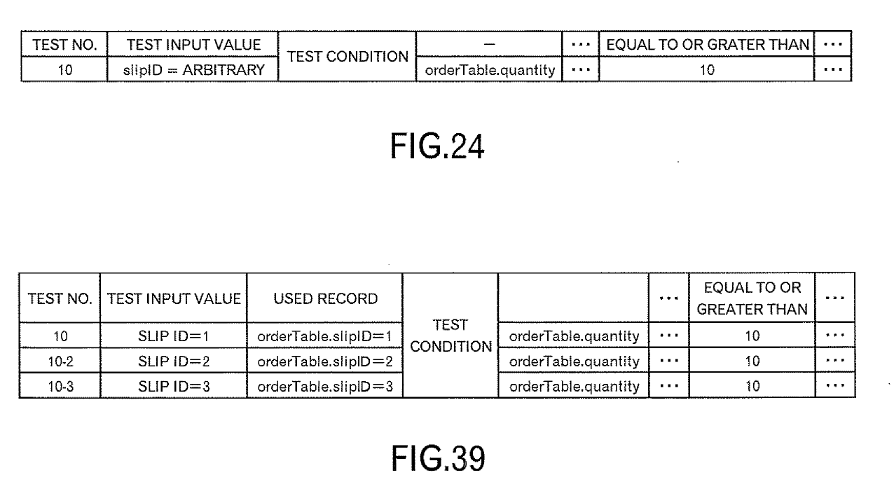

Next, an operation of the apparatus shown in FIG. 19 will be explained by using FIGS. 23 to 39. First, the test case input unit 201 prompts the user to input a test input value and a test condition, accepts inputs of the test input value and the test condition from the user, and stores them into the test case data storage 202 (step S101). For example, data as shown in FIG. 24 is stored in the test case data storage 202. In the example of FIG. 24, in a case of a test number “10”, a case where the quantity is equal to or greater than 10 in the order table of DB 152. In such a case, in the test number “10”, for the test input value, slipID=arbitrary is set. In addition, a condition “orderTable.quantity is equal to or greater than 10” is set as the test condition. As the test condition, “including value”, “not including value”, “greater than”, “less than”, “equal to or less than”, “identical”, “not identical” or the like can be set. However, they are omitted in FIG. 24. The user inputs the test input value and test condition by the test case input unit 201.

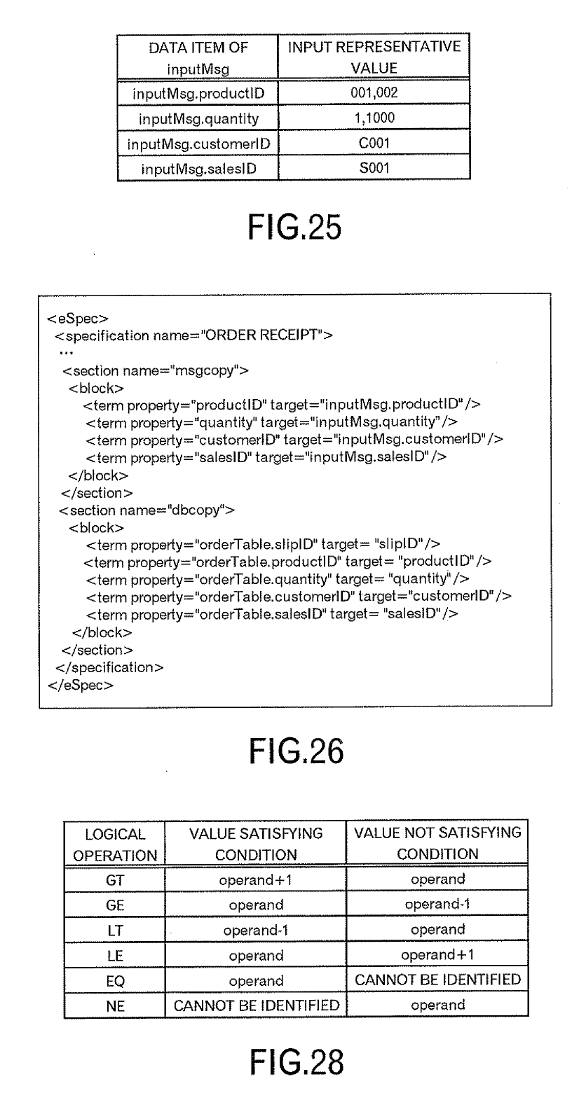

Next, the input representative value input unit 207 prompts the user to input the input representative values, accepts the inputs of the input representative values from the user, and stores the input representative values into the input representative value storage 208 (step S103). For example, data as shown in FIG. 25 is inputted and stored into the input representative value storage 208. In the example of FIG. 25, values “001” and “002” of the item “productID” included in the input message (i.e. inputMsg), values “1” and “1000” of the item “quantity”, value “C001” of the item “customerID”, value “S001” of the item “salesID” are inputted and stored.

Then, the specification reverse unit 205 carries out a generation processing of the reverse specification data by using data stored in the registration application specification data storage 203 and the input representative value storage 208 (step S105). Because this processing is the same as that in the first embodiment, the explanation is omitted. As a result, data as shown in FIG. 26 is stored into the reverse specification data storage 206. In addition, when the human being generates the reverse specification data, this step is skipped.

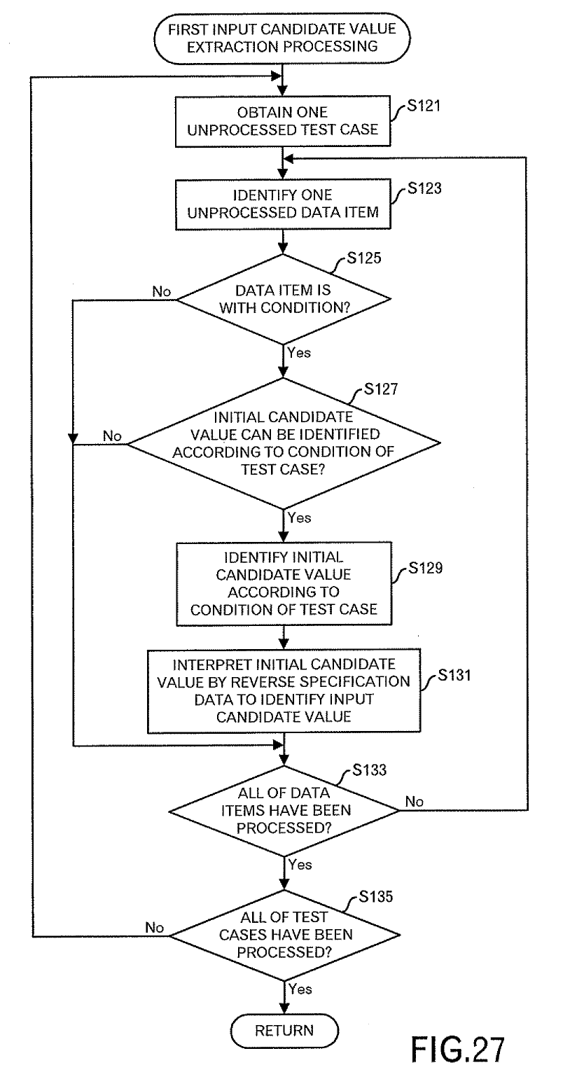

After that, the input message generator 209 carries out a first input candidate value extraction processing by using data stored in the test case data storage 202 and the reverse specification data storage 206 (step S107). The first input candidate value extraction processing will be explained by using FIGS. 27 to 29.

In the first input candidate value extraction processing, first, the input message generator 209 reads out one unprocessed test case from the test case data storage 202 (step S121). In addition, the input message generator 209 identifies one unprocessed data item to which an input candidate value should be set (step S123). Data items (i.e. data items in the order table) that correspond to data items (i.e. data items in the input message), which are outputs, and are starting points are identified among the reverse specification data stored in the reverse specification data storage 206, for example. In the example of FIG. 26, inputMsg.productID, inputMsg.quantity, inputMsg.customerID and inputMsg.salesID in a portion of section name=“msgcopy” are identified as data items, which are outputs, and orderTable.productID, ordertable.quantity, orderTable.customerID and orderTable.salesID, which correspond to them, are identified.

Next, the input message generator 209 judges whether or not a condition is defined for the data items identified at the step S123 in the test cases stored in the test case data storage 202 (step S125). In the example of FIG. 24, “equal to or greater than 10” is defined for the orderTable.quantity. Therefore, when any condition is not defined for the data items identified at the step S123, that is, in a case of the data items other than the orderTable.quantity, the processing shifts to the step S133. On the other hand, when a condition is defined for the data items identified at the step S123, that is, in a case of the data item of the orderTable.quantity, the input message generator 209 judges whether or not an initial candidate value can be identified according to the condition of the test case (step S127). For example, rules as shown in FIG. 28 are applied. In the example of FIG. 28, specific rules (operand+1, operand, operand−1, or cannot be identified) for a value satisfying the condition and specific rules (operand+1, operand, operand−1, or cannot be identified) for a value not satisfying the condition are defined respectively for GT (greater than), GE (greater than or equal to), LT (less than), LE (less than or equal to), EQ (equal to) and NE (not equal to). Here, in a case where the specific rule “cannot be identified” is defined for the value satisfying the condition, the processing shifts to step S133.

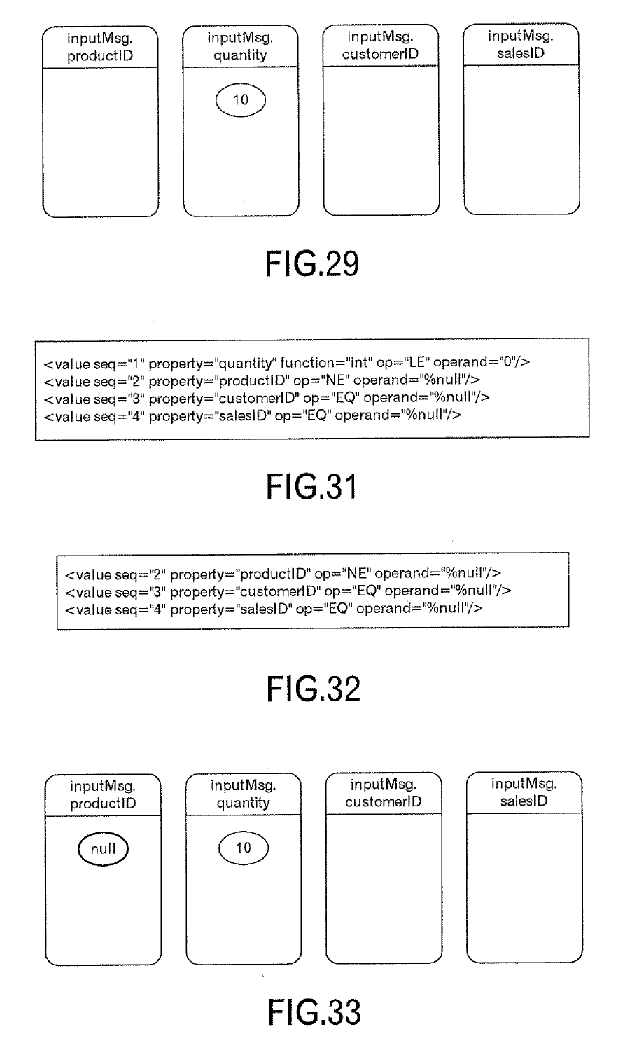

On the other hand, when an initial candidate value can be identified according to the condition of the test case, the input message generator 209 identifies an initial candidate value according to the condition of the test case (step S129). According to the rules of FIG. 28, in a case of the condition “equal to or greater than 10”, “10”, which is an operand, is identified as an initial candidate value as it is. Then, the input message generator 209 interprets the initial candidate value by the reverse specification data stored in the reverse specification data storage 206, identifies the input candidate value, and stores the identified input candidate value into a storage device such as a main memory (step S131). For example, by using the reverse specification data as shown in FIG. 26, the data item in the order table is converted into the data item in the input message. In the example of FIG. 26, the simple copy is carried out. Then, for example, in the main memory, as shown in FIG. 29, an area to store input candidate values for the inputMsg.productID, inputMsg.quantity, inputMsg.customerID and inputMsg.salesID is secured, and “10” is stored in the area for the inputMsg.quantity.

Then, the input message generator 209 judges whether or not all of the data items have been processed (step S133). When the unprocessed data item exists, the processing returns to the step S123. On the other hand, when the processing is completed for all of the data items, the input message generator 209 judges whether or not all of the test cases have been processed (step S135). In the example of FIG. 24, only one test case is shown. However, when there are plural test cases and the unprocessed test case exists, the processing returns to the step S121. On the other hand, when all of the test cases have been processed, the processing returns to the original processing.

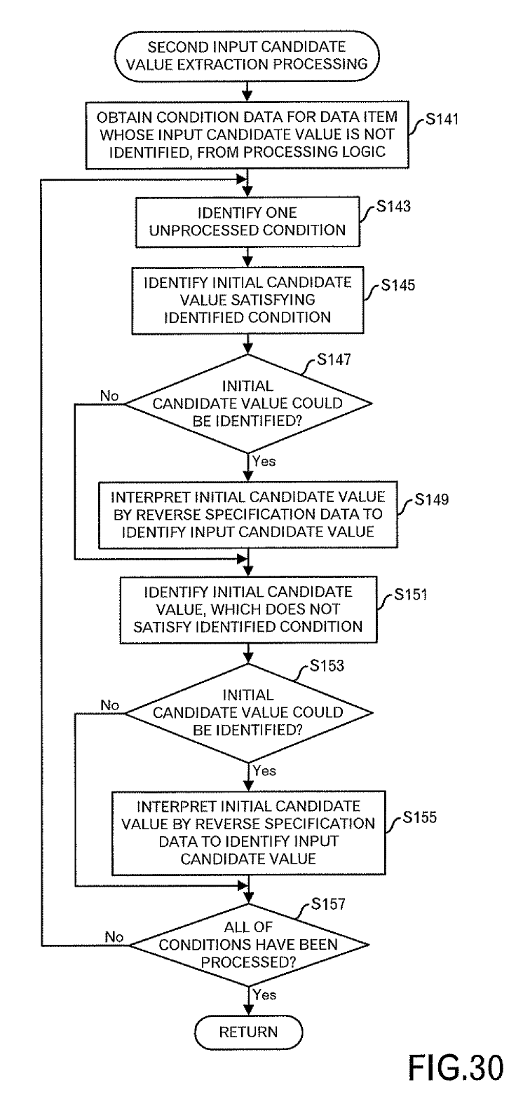

Returning to the explanation of the processing in FIG. 23, next, the message generator 209 carries out a second input candidate value extraction processing (step S109). The second input candidate value extraction processing will be explained by using FIGS. 30 to 35.

The input message generator 209 refers to the area storing the input candidate values in, for example, the main memory to obtain condition data for the data items for which the input candidate values have not been identified, from the processing logic (FIG. 21) in the specification data of the data registration application, which is stored in the registration application specification data storage 203 (step S141). In the example of FIG. 21, the condition data as shown in FIG. 31 is initially extracted, and when interpreting the condition data by the reverse specification data shown in FIG. 26, the inputMsg.quantity, inputMsg.productID, inputMsg.customerID and inputMsg.salesID are identified. However, because the inputMsg.quantity, for which data has already been registered in the area storing the input candidate value in the main memory, is excluded, the condition data is narrowed to the condition data as shown in FIG. 32.

Next, the input message generator 209 identifies one unprocessed condition among the conditions extracted at the step S141 (step S143). Then, the input message generator 209 identifies an initial candidate value satisfying the identified condition (step S145). In this processing, the specific rules shown in FIG. 28 are used. That is, in this step, the initial candidate value is identified according to the rules in the column “value satisfying the condition”. For example, in a case of the condition “productID” in the first line of FIG. 32, the initial candidate value cannot be identified because the logical operation is “NE”.

Here, the input message generator 209 judges whether or not the initial candidate value could be identified (step S147). When the initial candidate value cannot be identified, the processing shifts to the step S151. On the other hand, when the initial candidate value could be identified, the input message generator 209 interprets the initial candidate value by the reverse specification data, identifies an input candidate value, and stores the input candidate value into, for example, an area to store the input candidate value in the main memory (step S149).

When it is judged at the step S147 that the initial candidate value cannot be identified or after the step S149, the input message generator 209 identifies initial candidate values, which do not satisfies the identified condition (step S151). In this processing, the specific rules as shown in FIG. 28 are used. That is, in this step, the initial candidate values are identified according to the rules in the column “value not satisfying the condition”. For example, in a case of the condition “productID” in the first line of FIG. 32, the initial candidate value is “null” because the logical operation is “NE”.

Here, the input message generator 209 judges whether or not the initial candidate value could be identified at the step S151 (step S153). When the initial candidate value cannot be identified, the processing shifts to step S157. On the other hand, when the initial candidate value could be identified, the input message generator 209 interprets the initial candidate value by the reverse specification data to identify the input candidate value, and stores the initial candidate value into the area to store the initial candidate value in, for example, the main memory (step S155). In a case of the condition “productID” in the first line of FIG. 32, “null” is registered into the area for the inputMsg.productID as shown in FIG. 33.

Then, the input message generator 209 judges whether or not all of the conditions have been processed (step S157). When the unprocessed condition remains, the processing returns to the step S143. When all of the conditions have been processed, the processing returns to the original processing.

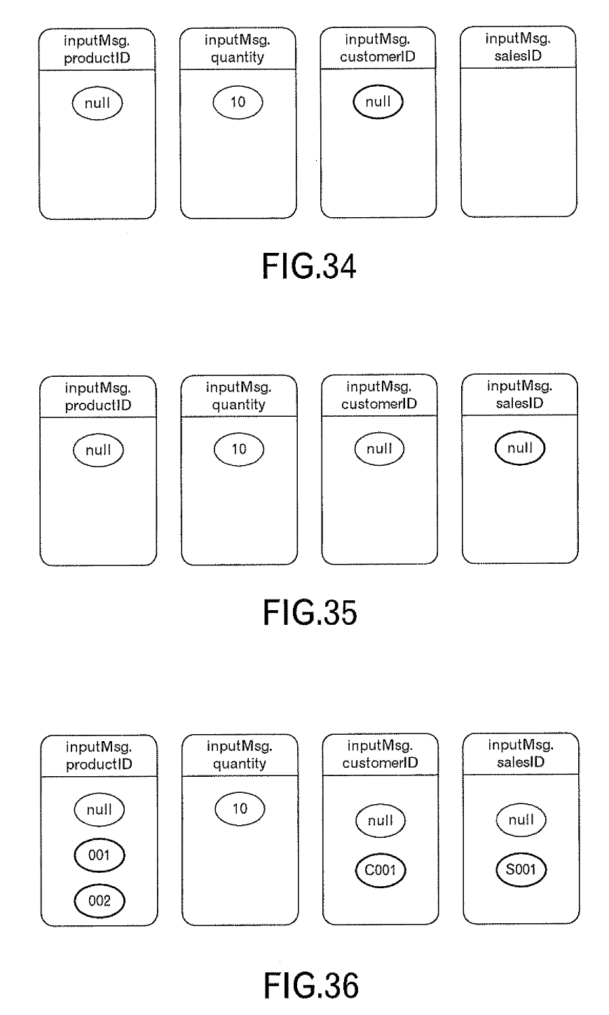

In a case of the condition “customerID” in the second line of FIG. 32, because the logical operation is “EQ”, “null” is registered into the inputMsg.customerID as shown in FIG. 34 at the steps S145 and S149. In a case of the condition “salesID” in the third line of FIG. 32, because the logical operation is “EQ”, “null” is registered into the inputMsg.salesID as shown in FIG. 35 at the steps S145 and S149.

Returning to the explanation of the processing of FIG. 23, the input message 209 additionally stores the input representative value as the input candidate value for the data items whose input candidate value was extracted in the second input candidate value extraction processing into the area to store the input candidate value in the main memory (step S11). In the aforementioned example, the inputMsg.productID, inputMsg.customerID and inputMsg.salesID are data items whose input candidate value was extracted in the second input candidate value extraction processing, and “001” and “002” are extracted for the inputMsg.productID, “C001” is extracted for the inputMsg.customerID, and “S001” is extracted for the inputMsg.salesID from the input representative values shown in FIG. 25, and they are additionally stored into the respective areas as shown in FIG. 36.

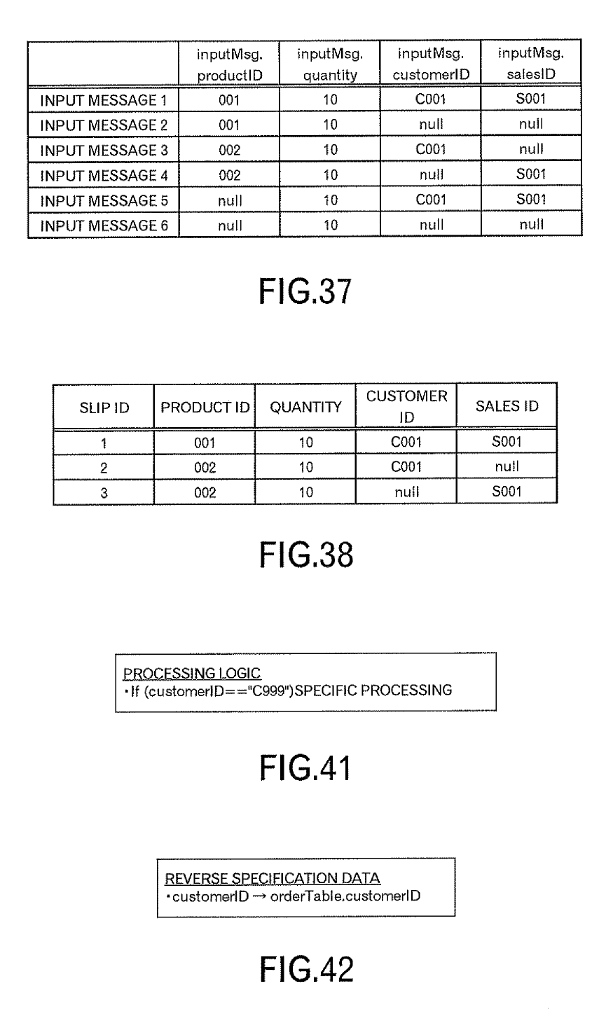

Then, the input message generator 209 combines the input candidate values of the respective data items by using a well-known method such as the orthogonal table or AllPair method to generate input messages, and stores the generated input messages into the input message storage 210 (step S113). For example, six input messages as shown in FIG. 37 are generated. However, because, in the step S113, it is not considered whether or not the input message passes the check in the processing logic of the data registration application 151, not all of the generated input messages are effective.

Then, the input execution unit 211 reads out an input message from the input message storage 210, and causes the data registration application 151 to output the input message to carry out a processing to register data into the DB 152 (step S115). For example, because the processing logic as shown in FIG. 22 is applied, the input messages 2, 5 and 6 among the input messages shown in FIG. 37 cause an error and are not registered into the DB 152. Therefore, data as shown in FIG. 38 is registered in the order table of DB 152. Incidentally, the slip ID is issued in the data registration application 151.

After that, for the user who carries out the test, the test case generator 213 generates data of the test case based on the data registered in the DB 152, and stores the generated data into the test case data storage 202 (step S117). If necessary, the test case stored in the test case data storage 202 may be outputted to an output device such as a display device or printer. In the aforementioned example of FIG. 24, the slip ID was arbitrary. However, because records whose slip IDs are 1 to 3 are registered into the DB 152 after the input messages were inputted, the test case generator 213 expands the test case to the test cases, which designate the respective slip IDs as the primary keys. Specifically, as shown in FIG. 39, a test case 10 for the record whose slip ID is “1”, a test case 10-2 for the record whose slip ID is “2”, and a test case 10-3 for the record whose slip ID is “3” are generated and stored into the test case data storage 202.

By carrying out the aforementioned processing, because variations of the input messages increase and it becomes possible to carry out tests for various cases, it is possible to reduce the development costs and enhance the test efficiency by preventing the leakage of the test items and reducing the return back in the development.

### Embodiment 3

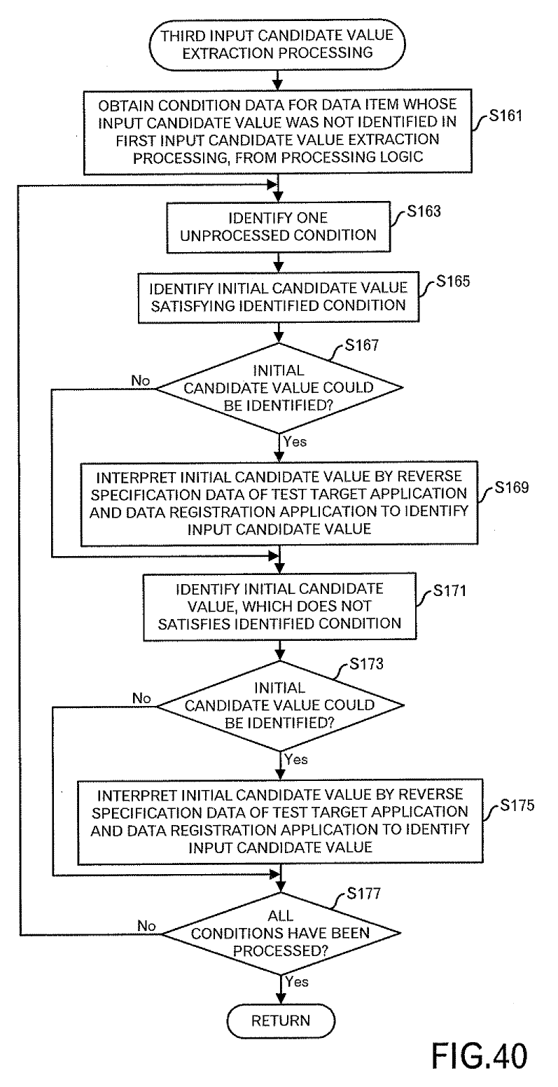

In the second embodiment, by using the specification data of the data registration application 151, the variations of the input candidate values are increased. However, in this embodiment, by using the specification data of the test target application 153, the variations of the input candidate values are increased. The basic processing flow is the same as that in FIG. 23, but after the step S109, a processing as shown in FIG. 40 are carried out. Incidentally, in the step S105, the reverse specification data of the test target application 153 is also generated.

That is, the input message generator 209 refers to the area to store the input candidate values in, for example, the main memory to obtain condition data for the data items for which the input candidate value cannot be identified in the first input candidate value extraction processing from the processing logic in the specification data of the test target application 153, which is stored in the test target application specification data storage 204 (step S161). For example, here, as shown in FIG. 41, the condition for the inputMsg.customerID is obtained. Incidentally, by using the reverse specification data (i.e. the reverse specification data of the copy information. FIG. 42 shows a schematic drawing.) and the reverse specification data of the data registration application 151 as shown in FIG. 26, the correspondence relation with the data items in the input message is identified.

Next, the input message generator 209 identifies one unprocessed condition among the conditions extracted at the step S161 (step S163). Then, the input message generator 209 identifies the initial candidate value satisfying the identified condition (step S165). This processing follows the specific rules shown in FIG. 28. That is, in this step, according to the rules in the column of “value satisfying the condition”, the initial candidate value is identified. For example, in a case of the condition “customerID” of FIG. 41, because the logical operation is “EQ”, the initial candidate value is “C999”.

Here, the input message generator 209 judges whether or not the initial candidate value could be identified (step S167). When the initial candidate value could not identified, the processing shifts to step S171. On the other hand, when the initial candidate value could be identified, the input message generator 209 interprets the initial candidate value by the reverse specification data of the test target application 153 and the reverse specification data of the data registration application 151 to identify the input candidate value, and stores the input candidate value into the area to store the input candidate value in, for example, the main memory (step S169).

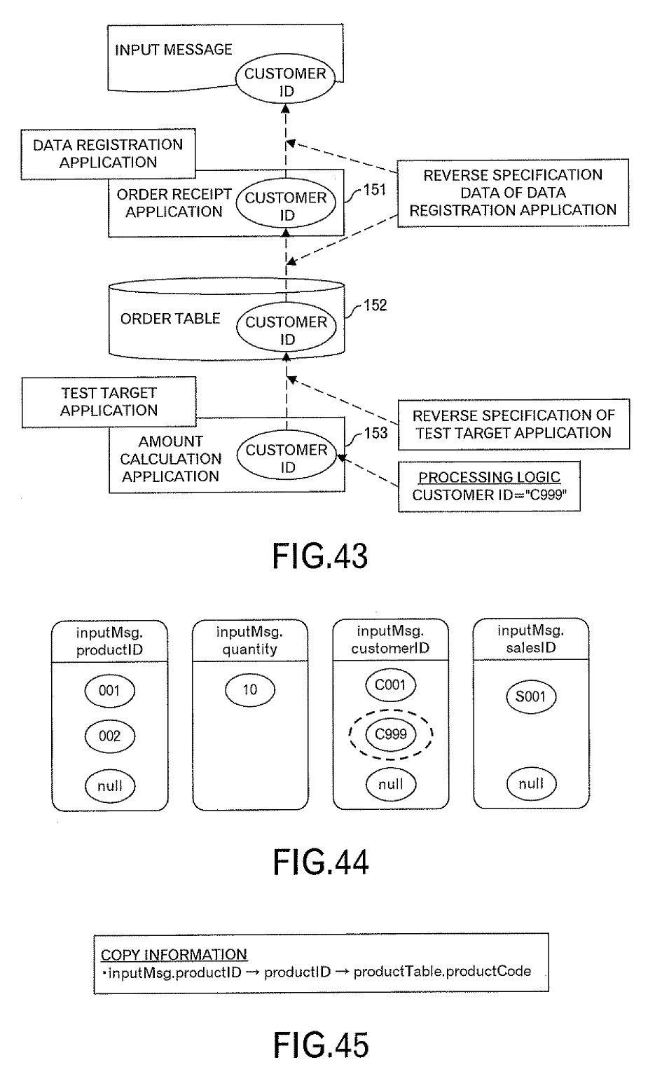

FIG. 43 shows a schematic drawing of the processing of the step S169. Because the processing logic “customerID=“C999”” is a processing logic in the amount calculation application, which is the test target application 153, “orderTable.customerID” is identified as the corresponding data item in the order table of the DB 152 by the reverse specification data of the test target application 153. Furthermore, in order to copy and convert the data item “orderTable.customerID” in the order table of the DB 152 into the data item “customerID” in the order receipt application, which is the data registration application 151, the reverse specification data (portion of section name=“dbcopy”) of the data registration application 151 is used. Moreover, in order to copy and convert the data item “customerID” of the data registration application 151 into the data item “inputMsg.customerID” in the input message, the reverse specification (portion of section name=“msgcopy”) of the data registration application 151 is used. Then, as shown in FIG. 44, “C999” is registered for the inputMsg.customerID.

When it is judged at the step S167 that the initial candidate value cannot be identified, or after the step S169, the input message generator 209 identifies the initial candidate value, which does not satisfy the identified condition (step S171). This processing follows the specific rules shown in FIG. 28. That is, according to the rules of the column “value not satisfying the condition”, the initial candidate value is identified at this step. For example, in a case of the condition “customerID” of FIG. 41, because the logical operation is “EQ”, the initial candidate value “cannot be not identified”.

Here, the input message generator 209 judges whether or not the initial candidate value could be identified at the step S171 (step S173). When the initial candidate value could not identified, the processing shifts to the step S177. On the other hand, when the initial candidate value can be identified, the input message generator 209 interprets the initial candidate value by the reverse specific data of the test target application 153 and the reverse specific data of the data registration application 151 to identify the input candidate value, and stores the input candidate value into the area to store the input candidate value in, for example, main memory (step S175). This processing is a processing as explained in FIG. 43.

Then, the input message generator 209 judges whether or not all of the conditions have been processed (step S177). When there is an unprocessed condition, the processing returns to the step S163. When all of the conditions have been processed, the origin processing returns to the original processing.

By carrying out such a processing, as shown in FIG. 44, it is possible to increase the variations of the input candidate values and further increase the variations of the input messages. Especially, by including a value for which a special treatment is considered to be carried out in the processing logic of the test target application 153 into the input candidate values, it becomes possible to carry out the test without the leakage.

### Embodiment 4

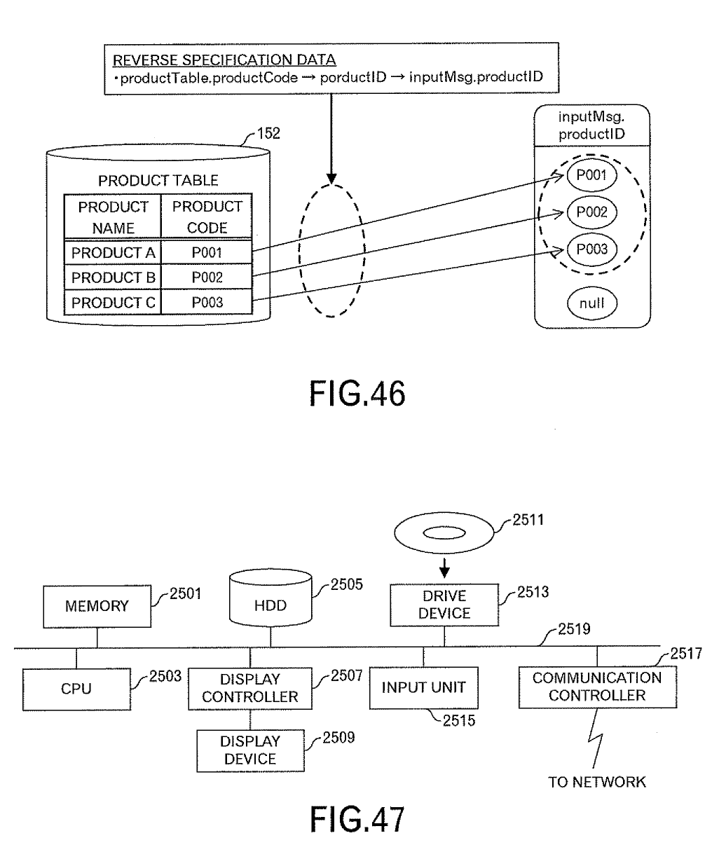

In the third embodiment, an example that the input candidate value is generated from the input representative value after the second input candidate value extraction processing was shown. In this fourth embodiment, the copy information included in the specification data of the data registration application 151 is used. Specifically, when the copy information schematically shown in FIG. 45 separately exists, data, which has been registered in the product table in the DB 152, can be used for the input candidate value. As schematically shown in FIG. 46, the input message generator 209 uses the reverse specification data of the copy information to convert the value of the product code in the product table into the input candidate value of the inputMsg.productID, and registers the input candidate value.

Thus, by using data used in other table, that is, data having the consistency, it becomes possible to enrich the input candidate values and increase the variation of the input messages.

Although the second to fourth embodiments of this invention were described above, this invention is not limited to this invention. For example, the functional block diagram shown in FIG. 19 is a mere example, and that does not always correspond to the actual program module configuration.

Incidentally, the test data registration apparatuses as shown in FIGS. 2 and 19 are computer devices as shown in FIG. 47. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 47. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in detail are realized.

### APPENDIX

### [XML Specification Description Method]

There is a case where a processing such as a range check, data copy and conversion is executed for the data item such as data Bean, HashMap (java.util.HashMap), and XML data Bean (com.fujitsu.uji.xml.XMLDataBean) on a Web server. The XML data specification description is a function to describe, in the XML format, the copy processing and the check processing of the data items whose specification change, which depends on the business, is frequent, into an external file, and to execute such a processing. By describing the specification into the external file, it becomes possible to cope with the specification change without changing the program, and it is expected that the maintenance capability is improved.

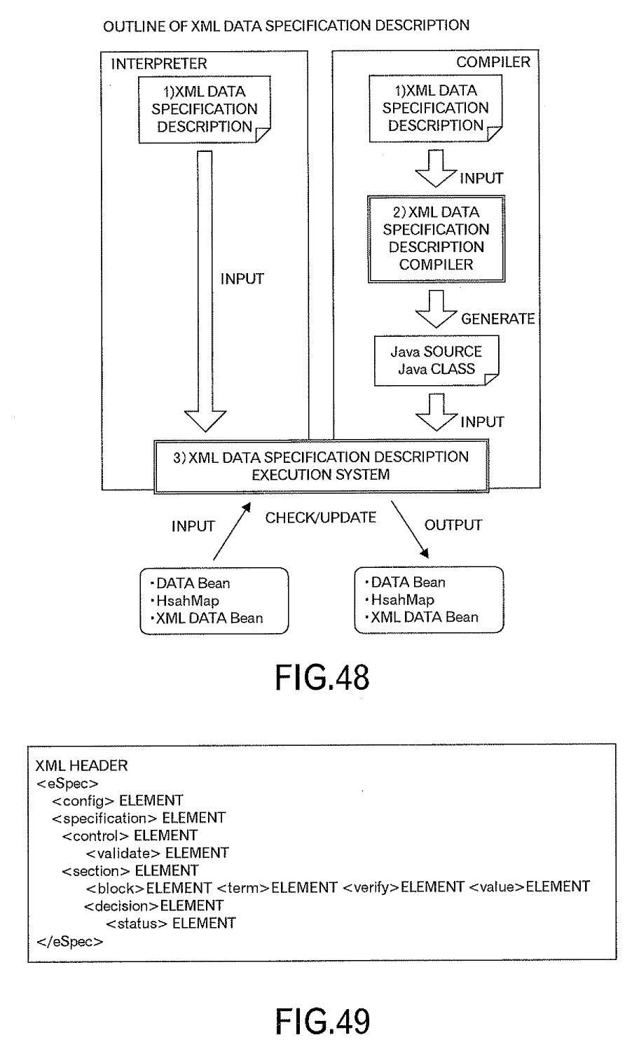

A system outline, which utilizes the XML data specification description, is indicated in FIG. 48.

### 1) XML Data Specification Description

The user describes the specification such as a data range, matching of the character string pattern and the like in the XML format, for each data item. The usable data items are data items of the data Bean, Hash Map and XML data Bean. In the execution time, it is possible to execute the XML file as it is by using the interpreter function, or compile and execute the XML file by using the compiler function. By executing the XML file as it is, it is possible to cope with the changes of the data check specification or the like without changing the program.

### 2) XML Data Specification Description Compiler

It is possible to compile the created XML data specification description to classes of the Java (registered trademark) and use the generated classes. The XML data specification description compiler generates and outputs the Java source file from the XML data specification description. Because there is no need to analyze the XML in the application execution, the execution capability is enhanced compared with a case where the XML file is used as it is.

### 3) XML Data Specification Description Execution System

The created XML data specification description is executed. As inputs, data Bean, HashMap and XML data Bean can be used. It is possible to refer to or update the data items of the objects, which are designated as the inputs, and to update the data item of the output destination object.

The outline of the XML data specification description is shown in FIG. 49. The outline of each element is as follows:

a) Config Element

This element designates information of XML data specification description.

b) Specification Element

This element indicates a unit of the processing. In the execution time of the XML specification description, by using a name designated in the name attribute of this element, the processing is called.

c) Control Element

This element designates an order of the check and a check target object. The processing is executed in an order of the validate elements described in this element.

d) Validate Element

Section element to be executed is designated in the section attribute of this element.

e) Section Element

This element indicates an execution unit of a series of processing.

f) Block Element

This element designates a judgment range of the condition.

g) Term Element

This element designates the condition and operation in a case where the condition is true.

h) Verify Element

This element designates the condition and operation to be executed in a case where the condition is false.

i) Decision Element

This element designates an operation to be executed in a case where a set of conditions, which are stored in the value element, is true.

j) Status Element

This element indicates a judgment condition of the decision element.

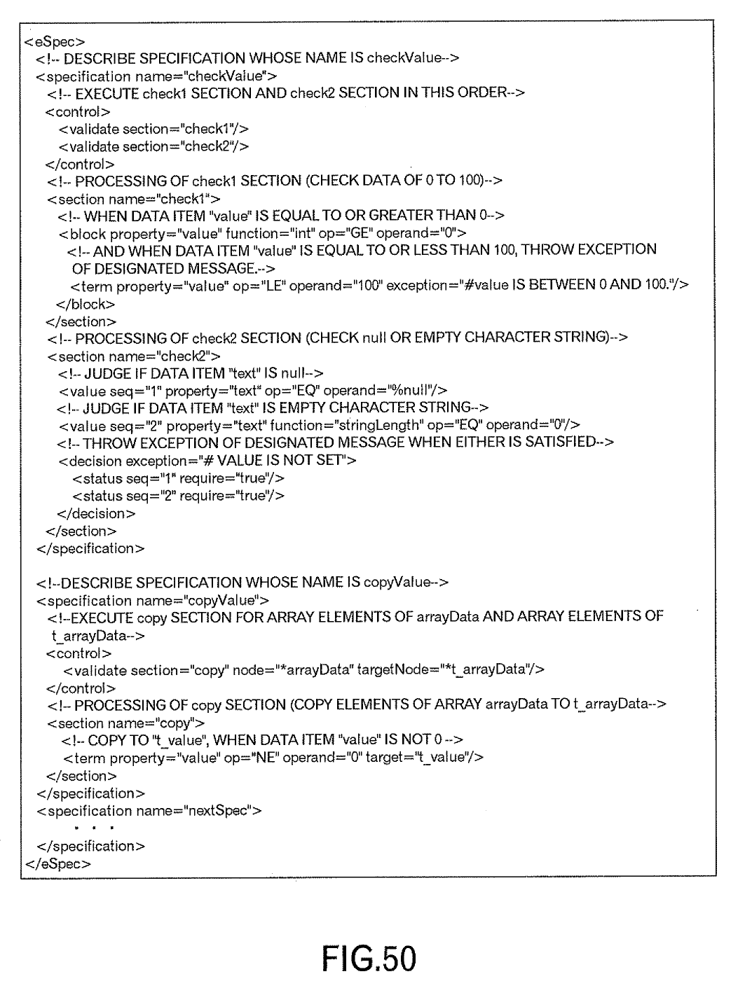

Next, an example of the description of the XML data specification definition is shown in FIG. 50, and the outline of the operation will be explained.

a) a case where the tag of specification name=“checkValue” is called
1. execute validate tags designated in the control tag in sequence. In the example, the pertinent section tags are called in the order of check 1 and then check 2.
2. check, by the tag of section name=“check1”, which was firstly called from the control tag, whether or not the value of the value item is data from 0 to 100.

### 3. When the value of the value item is data from 0 to 100 as the check result, an exception of ESpecResultException, which has a character string “the value is within a range from 0 to 100”, is thrown.

### 4. When any exception does not occur in the check1, the tag of section name=“check2” is called from the control tag,

5. check, by the tag of section name=“check2”, whether or not the value of the data item “text” is null or empty character string.

### 6. When the value of the text item is null or empty character string, as the check result, an exception, which has a character string “any value is not set” is thrown.

### 7. When any exception is not caused in the check2, the processing normally ends.

b) a case where the tag of specification name=“copyValue” is called
1. execute the validate tag designated in the control tag. In the example, the copy section is executed for the array element of arrayData and the array element of t_arrayData by the number of elements.
2. copy to “t_value” by the tag of section name=“copy” called from the control tag, when the data item “value” is not 0.
3. after the execution of copy section by the number of elements, the processing normally ends.

Next, usable object expressions and operators will be explained. In the following XML description, the object expression can be described for the property attribute and the operand attribute in the term element. <term property=“value” op=“LE” operand=“100” exception=“#value should be from 0 to 100.”/>

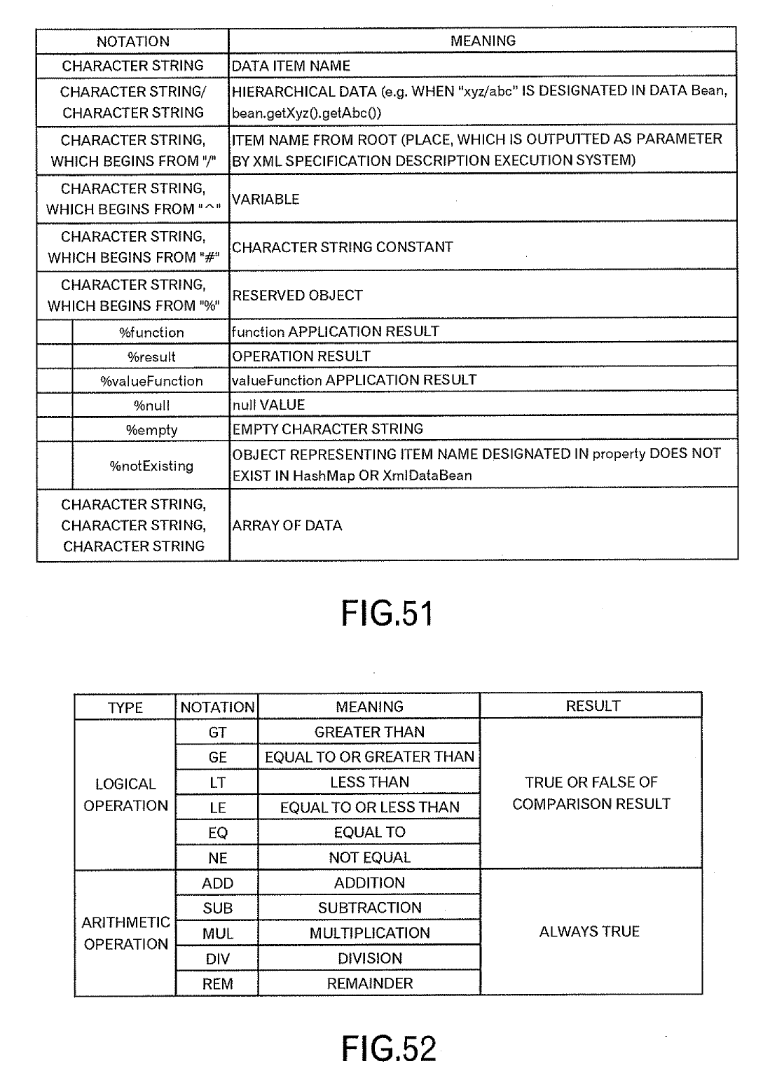

A list of the object expressions, which can be described, will be shown in FIG. 51.

In addition, a logical operator or calculation operator can be designated in the op attribute. The operators, which can be designated, will be shown in FIG. 52.

Furthermore, a method, which is applied to property, can be described in the function attribute of the value element in the following XML description. <value seq=“2” property=“text” function=“stringLength” op=“EQ” operand=“0”/>

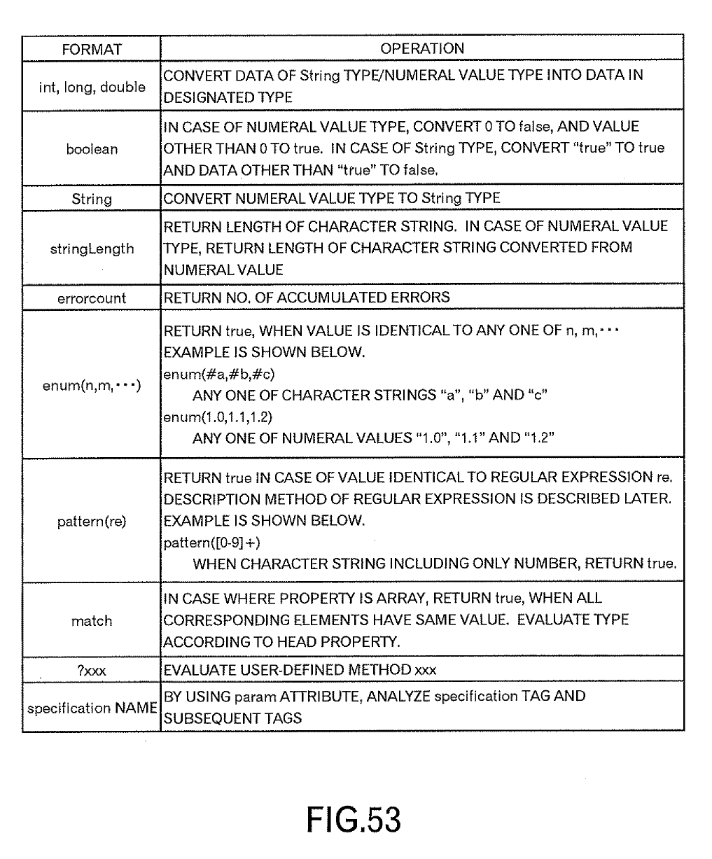

The methods, which can be described, will be shown in FIG. 53.

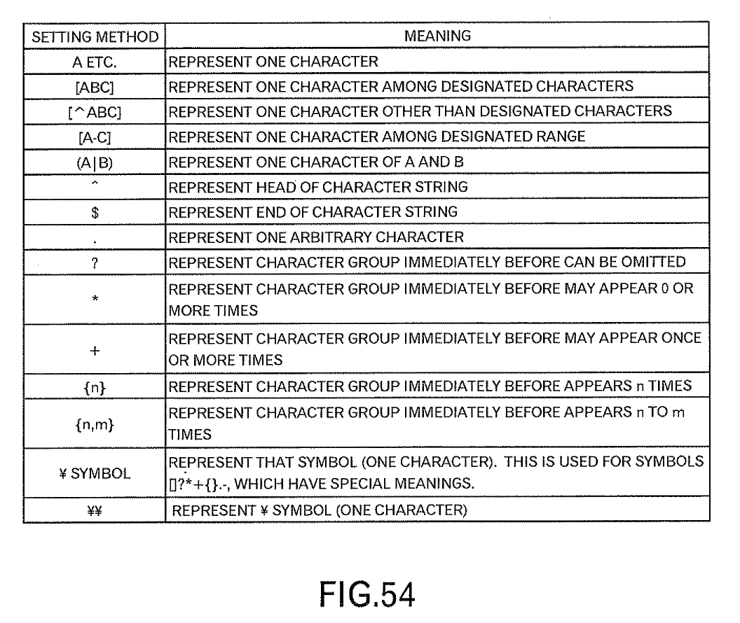

In addition, the description method shown in FIG. 54 can be used for the regular expression.

Furthermore, the definition method of the user method is as follows:

In the XML data specification description, a static method and a method of a class, which inherits ESpecValidator class, can be used as the user method. The definition method of the user method will be explained in the following.

a) The static method is used.

In the XML data specification description, the static method can be invoked. As the invocation method, it is designated in a format “package name.class name.method name” in the function attribute or valueFunction attribute. An example is shown below.

### XML data specification description example

<term property=“abc” function=“some_package.some_class.some_function”/>

### An example of the user method

package some_package; class some_class {static void some function(String arg1) { . . . }}
b) A method of a class, which inherits ESpecValidator class, is used.

An example that ESpecValidator class is inherited and a method of the class is invoked is shown below.

### XML data specification description example

<term property=“abc” function=“some_function”/>

### An example of the user method

class SomeClass extends EspecValidator {void some_function (String arg1){ . . . }}

The parameters are defined in the following format.

a) arbitrary type some_function(arbitrary type, . . . )

The type matching to an arbitrary type is automatically carried out. However, when the type matching cannot be carried out, an exception occurs.

b) arbitrary type some_function(Object [ ]args);

The parameter is outputted in an array of the Object type.

An example that the plural parameters are outputted to the user-defined method is shown below. When plural objects are described in the property attribute in such a manner that the plural objects are separated by the comma, they are invoked in sequence in association with the parameters of the user-defined method. In the following example, a numeral value “1” is outputted to param1 of some_function, a character string “abc” is outputted to param2 of some_function, and a numeral value “2” is outputted to param3 of some_function.

### XML data specification description example

<term property=“1, #abc, 2” function=“some_function”/>

### An example of the user method

void some_function(int param1, String param2, int param3){ . . . }

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A method for registering data used for a test of an application using a database into said database by using a data registration application, said method comprising:
obtaining data concerning a test condition;
generating an input candidate value for said data registration application based on said data concerning said test condition and reverse specification data, which defines a reverse processing of said data registration application and is identified from specification data of said data registration application; and
inputting said input candidate value into said data registration application to carry out a registration processing to said database.

2. The method as set forth in claim 1, wherein said generating comprises:
generating an initial input candidate value for said data registration application according to said data concerning said test condition; and
generating said input candidate value from said initial input candidate value by using said reverse specification data, which defines said reverse processing of said data registration application.

3. The method as set forth in claim 2, wherein said generating said initial input candidate value and said generating said input candidate value are carried out for each data item for which said data concerning said test condition is defined.

4. The method as set forth in claim 2, wherein said generating said initial input candidate value comprises:
upon detecting that said initial input candidate value cannot be directly identified from said data concerning said test condition, identifying an input representative value as said initial input candidate value.

5. The method as set forth in claim 1, wherein said generating comprises:
identifying an input representative value, as said initial candidate value, for an data item for which said data concerning said test condition is not defined.

6. The method as set forth in claim 1, further comprising:
generating said reverse specification data, which defines a reverse processing of said data registration application, from said specification data of said data registration application.

7. The method as set forth in claim 6, wherein said generating said reverse specification data comprises:
changing an operation in a data input or a data check within said specification data of said data registration application to a reverse operation; and
interchanging an input item and an output item in said data input or said data check within said specification data of said data registration application.

8. The method as set forth in claim 1, wherein said data registration application refers to a second database, and said generating and said inputting are carried out for a second data registration application for registering data into said second database.

9. The method as set forth in claim 2, wherein said generating further comprises:
generating a second initial input candidate value for said data registration application, from a processing logic included in said specification data of said data registration application, for a data item for which said initial input candidate value cannot be identified from said data concerning said test condition; and
generating said input candidate value from said second initial input candidate-value by using said reverse specification data, which defines said reverse processing of said data registration application.

10. The method as set forth in claim 9, wherein said inputting comprises:
generating a plurality of messages by combining said input candidate values for each data item, and
inputting said plurality of messages into said data registration application.

11. The method as set forth in claim 2, wherein said generating further comprises:
generating a third initial input candidate value for said data registration application from a processing logic included in said specification data of said application using said database, for an data item for which said initial input candidate value cannot be identified from said data concerning said test condition; and
generating said input candidate value from said third initial input candidate value by using second reverse specification data, which defines a reverse processing of said application using said database and said reverse specification data, which defines said reverse processing of said data registration application.

12. The method as set forth in claim 1, further comprising:
extracting said input candidate value from data, which has been already registered into said database.

13. The method as set forth in claim 1, further comprising:
generating new data concerning said test condition from said data concerning said test data and records registered in said database in said inputting.

14. A program embodied on a computer-readable medium, for causing a computer to register data used for a test of an application using a database into said database by using a data registration application, said program comprising:
obtaining data concerning a test condition;
generating an input candidate value for said data registration application based on said data concerning said test condition and reverse specification data, which defines a reverse processing of said data registration application and is identified from specification data of said data registration application; and
inputting said input candidate value into said data registration application to carry out a registration processing to said database.

15. An apparatus for registering data used for a test of an application using a database into said database by using a data registration application, comprising:
a unit that obtains data concerning a test condition;
a unit that generates an input candidate value for said data registration application based on said data concerning said test condition and reverse specification data, which defines a reverse processing of said data registration application and is identified from specification data of said data registration application; and
a unit that inputs said input candidate value into said data registration application to carry out a registration processing to said database.
